(19) United States
(12) Patent Application Publication
(10) Pub. No.: US 2002/0161680 A1
(43) Pub. Date: Oct. 31, 2002

(54) Methods for managing and promoting network content

(76) Inventor: Harry L. Tarnoff, Sherman Oaks, CA (US)

Correspondence Address: KNOBBE MARTENS OLSON & BEAR LLP, 2040 MAIN STREET, FOURTEENTH FLOOR, IRVINE, CA, 91614, US

(21) Appl. No.: 10/055,626

(22) Filed: Jan. 22, 2002

Related U.S. Application Data
(60) Provisional application No. 60/263,148, filed on Jan. 22, 2001.

(51) Int. Cl. G06F 17/60

(52) U.S. Cl. 705/35

(57) ABSTRACT

Methods for enabling a content node of a network to automatically notify one or a plurality of other nodes about changes to the content of the content node. The methods enable a node including a website to efficiently update the information and content of search engines connected to the network. The methods also can be used to filter, block and enhance the content transmitted by the content node over the network. The methods further facilitate E-commerce and data rights management (DRM) functions over this network.

### PRIORITY CLAIMS

This application claims the benefit of U.S. Provisional Application No. 60/263,148 filed Jan. 22, 2001 entitled “Systems and Methods for Managing and Promoting Network Content”.

### FIELD OF THE INVENTION

This invention relates to content management, content promotion and e-commerce transactions on computer networks.

### BACKGROUND OF THE INVENTION

The Internet is a decentralized public network containing different groups of content, each content group organized by many different people using different standards and updated with a number of different processes. Clients, generally people sitting at their computers or with portable devices or other type of computing equipment, access information on a network through software applications. They attempt to locate information and access content from one or more content groups. For example, using their browser such as Microsoft Internet Explorer or Netscape Communicator, clients go to a search engine website and enter their search criteria, at which point the search engine website responds with a search result list of possible content locations, typically other websites, that are derived from matching entries in the search engine's database. As another example, clients use Personal Data Assistants (PDAs) or cell phones to locate and access network information in a wireless manner.

Often, a search engine responds to a client's request with data from its database that is out of date. When the content of a web site is changed, including new content being added or old content removed, a search engine database does not immediately reflect these changes. The result is that when a user clicks on the out-of-date web page link provided by a search engine in response to a search request, an error results and the user is unable to access the intended content. The timeliness and quality of people's access to web sites then is conditional on how fast the search engine companies can keep their databases up-to-date.

Most, although not all, search engine organizations construct computer applications called “spiders” or “bots,” a short form of the term “robots,” that work their way through the myriad of websites on the Internet and gather content information for their search engine's databases. A search engine organization specifies their bots' operating environment and methods of operation including rules to include or exclude particular content.

Inherently, a search engine bot has to traverse nearly the entire Internet so as to evaluate as much network content as possible. The cycle time of most search engine bots, that is the time between sampling the same website and incorporating any changes into the search engine's database can be significant, as long as several months. If a particular website is down, or offline, when a bot comes around to examine it, at the very least it will not have its content updated until some future time. Worst case, it could be excluded from the search engine's database entirely. Should this happen, clients performing searches using that particular search engine would never be informed about the website since it would not appear in the search engine's database. As more websites come online, the amount of time for a search engine's bot operation to traverse the entire network continues to increase, requiring additional computing resources, with no end to this time-delay problem in sight.

Even when a user is able to access a location on a website through a link provided by a search engine, the content can still be out-of-date. For example, if a user searched for a particular product item, he or she could be lead to a website that once carried but no longer carries the item. This particular out-of-date condition is so prevalent that leading search engine companies such as Google have resorted to installing a huge amount of data storage to hold a copy, buffer or cache of all content qualified for processing or storage by their bots. Clients of these search engines can then bring up the cache guaranteed to contain content matching the search criteria instead of the current up-to-date web page which may not. Some search engines keep a list of specific websites to scan more frequently such as news reporting agencies so that they can appear to be more responsive to newsworthy items.

Once the content has been gathered by a search engine and recorded in its database, it is up to the designers of the search engine to determine the manner in which data is returned from the search engine's database in response to any particular user request. Each search engine company has its own algorithms for generating responses, so a user might try several different search engines before being satisfied with the amount and quality of the search results.

A vast amount of restricted network content and information is not available for searching by network clients on typical search engines. Some websites restrict the access of a portion of their content to registered users and/or to users who have made a payment for accessing the content. Since search engine bots are not typically registered users, they are unable to gain access to the restricted content of a website and, therefore, unable to include that content in their search engines' databases. As a result of this limitation, clients of search engine clients are handicapped because they are not aware of the existence of content that could be useful to them. As a result, a client often has to remain ignorant of the existence of the restricted content or be a registered user to many additional websites, some of who charge the client a monthly access fee.

Websites are hosted on a computing platform of some particular typical configuration and utilize a web server application to process requests coming to it over the Internet. There are a number of different configurations for website hosting including but not limited to using operating systems such as Windows NT, Unix, and Linux, and using web server software such as Internet Information Server from Microsoft and Apache from the Apache Software Foundation. One computer can be used to host a website or a computer can host several websites especially if the websites are small and the computing resources can be shared. For particularly complex websites, multiple computers may be required. The term “computing platform” is used to signify that one or more computers might be required to support a particular website.

An unsecured web server will respond to Internet requests in a rote fashion, providing content on demand without any significant amount of consideration as to who is making the request. A secured web server is more discerning. It would employ at least one type of user authentication, such as a user ID and access password or public key encryption such as VeriSign's GoSecure! product. Today, network applications can avail themselves of an advanced public key infrastructure, commonly referred to as PKI, to ensure private and hacker-proof electronic transactions and communications across the network, particularly for e-commerce activities and Digital Rights Management (DRM). Secured web servers are often used when a user is placing an order, making a purchase or providing personal or sensitive information.

Additional software can be added to a web server to enhance its capabilities, either for the web site administrator or for the Internet users who may visit the web sites located on the web server. For example, a software program can be installed to monitor the amount of available disk space of a web server. Should the amount of available disk space drop below a certain preset threshold, the web server's administrator can be alerted through a paging system.

Filtering and blocking software applications allows parents, educators and other interested parties such as libraries to limit the type of materials viewed by children and teenagers on a network, particularly sexually explicit and hate related material. Network content filtering and blocking software exists in a number of different forms, mostly by a software application installed on the client side of the network. One method of blocking is to utilize a list of known websites from which to block content. A method for filtering is to allow content to be received from the website by the client's computer where the filtering software analyses and makes a determination. Not only is having the unnecessary content transmitted over the network a waste of resources, but also these methods for filtering and blocking content have been deemed by various studies to be only partially effective.

Access by people at large to personal computers and the Internet has changed the methods by which digital media content such as news reports, articles, books, music and films are produced, distributed and then used by the consumer. Accessing content online and downloading secured files has gained acceptance among many people primarily because of convenience; it provides ways to immediately access content, replacing more-involved physical trips to stores and an otherwise higher reliance on physical media such as Compact Discs, or CDs, and Digital Versatile/Video Disc, or DVDs. However, in spite of tremendous awareness in media marketplaces, digital media content has yet to become a staple for most consumers because what is available for sale on the Internet is limited.

Content creators, owners, publishers and others involved in the creation, support and delivery are concerned about protecting their copyrighted works from illegal use. Since digital content available for sale on the Internet is still an emerging concept, content owners are exploring new ways to enable different business models. With the success of these new models, it is likely that we will see more premium content become available on the Internet.

An example of a web site limiting its content are, e-commerce sites that purvey pure content such as online magazines, or e-zines as they are sometimes called. Typically their sites sell costly periodic subscriptions which limit their consumer base since, in many cases, consumers view subscriptions as unappealing as they would much prefer to only pay for accessing certain packets of content. These sites' valuable content is hidden from search engines, and is available only to subscribers. Since a site has most of its content hidden, the site itself may be difficult for consumers to discover, further reducing the effective customer base. Although some sites offer limited and scaled-down access for reduced fees for the consumers who do visit, it would be better if there were a way to offer subsets of the valuable content in a manner more consistent with traditional brick and mortar stores such as newsstands and bookstores.

For providers of high quality digital content to offer their copyrighted works for sale, secure e-commerce transactions are needed that protect this content from illegal use. One critical component of a state-of-the-art e-commerce system is digital rights management, or DRM, a combination of technologies used by content providers to automatically protect their copyrighted material. DRM promises to deliver digital content to consumers while protecting the rights of the content's creators, promoters, and distributors. Often, DRM is envisioned as a system that encrypts digital content, limiting access to only those people who have legitimately acquired authorization to access and read, listen to or watch the content. So far, limitations in traditional software and hardware have made it difficult for content providers to find a fast, reliable, long-term, and hacker-proof methods.

### DEFINITION OF TERMS

The Internet is referred to within this document by way of example as the most widely known network and one of the most complex networks in existence. Although the preferred embodiment of this invention is particularly well suited for the huge global computer network known as the Internet, this invention provides significant features and advantages for content providing computer networks. Thus, as used herein, the term “network” refers to any distributed computer network whether it be a local area network, or LAN, a wide area network, or WAN, an Intranet or the Internet, also known as the global computer network.

The terms “content” and “information” are used. Although content is clearly a form of information as used herein, the term “content” refers to data already accessible in one form or another on the network. As used herein, the term “information” is not intended to be limited in any way and to include, for example, any data that is derived from content, for example, a synopsis of content such as what might be provided by a search engine or the results of a computing algorithm such as the scoring of content for a particular purpose like content filtering.

Also, the terms “e-commerce” and “Digital Rights Management,” or “DRM,” are used. As used herein, the term “e-commerce” refers to the conduction of commerce over a network. The parties involved in the commerce can be any combination of people and non-human agents, and the exchange can involve network content, physical assets, or other goods and services. Although DRM is clearly a form of e-commerce, the term “DRM” refers to an e-commerce exchange that involves one or more secured transmissions in an effort to protect one or more digital rights including copyright, trade secret and other intellectual property rights. The terms “e-commerce” and “DRM” are not intended to be limited in any way, are interchangeable, and include, for example, any direct or indirect purchase and sales transactions of text, graphics, music, movies, and combinations thereof.

### SUMMARY OF THE INVENTION

The preferred embodiment of the present invention is a high performance, distributed content management system having a plurality of advantages over the conventional method or organizing a network's content. Specifically, with the global computer network, or Internet, the management system adds components to the network enabling enhanced bidirectional website communications. This new ability allows, for example, a website to automatically and immediately notify other sites, databases and clients about changes to its content. This particular feature has a number of advantages. Instead of waiting for search engine bots to come around and gather information and whose cycles can be as long as several months, website updates can be reflected in search engine databases in a relatively short timeframe, typically only a few minutes or seconds. The update rate now being much faster ensures a more up-to-date result when a search engine user performs a search, and it eliminates the strong need to hold vast amounts of buffered or cached copies of network content. The owners and administrators of a particular website advantageously have their content and recent content changes reflected accurately by search engine computing platforms, the value to them being, depending of the type of website, faster and potentially higher visibility on the network and/or faster and potentially higher revenue.

Another feature of the present invention is that website administrators have an opportunity to specify more categorically how they would like the website's content represented in the various search engine databases. Instead of letting a search engine organization make the determinations, the creators and managers of a particular website can have a say in how their website contents are labeled, organized and represented by external databases.

In the preferred embodiment of the present invention, various kinds of events and errors can be detected, logged and reported to website administrators. Because of the local proximity of the present invention to the website's application software, this method of detection and reporting has a higher degree of reliability. Also, because of the method of operation described below, the present invention has a high immunity to modification by hackers.

One of the novel components of the preferred embodiment of the present invention is called a “RevBot,” a new network technology that mimics the behavior of a network data collection robot, but actually operates in reverse, from the point of view of a website. Besides other capabilities that are described below, a RevBot allows a website to efficiently update the information and content at other network nodes that pertain to the website, particularly search engine databases.

By working in a manner reverse to that of a search engine bot, a RevBot is installed on a website's computing platform and detects search engines and other qualifying databases and lists located remotely on the network. When it locates one of these nodes, it transmits or schedules the transmission of data relating to the website, such as a synopsis of the recently changed content, to the other node's computing platform. The RevBot can keep a list of these qualified nodes and their operating parameters as a reference for future updates. In this manner of operation, with the aid of RevBots, search engine updates can be sped up significantly.

If a node flagged to be updated is offline or is detected to be compromised in some way based on a set of programmable rules, the RevBot will perform error recovery that includes executing a combination of transmission retries and notifications to other nodes about the changed status of the update node. When the update node comes online or should the update node come online within a period of time, the RevBot transaction can then take place. Otherwise, the update node is ignored, recorded, or reported depending on the rules. The rules are either fully automatic or involve a person in the process. Updates can be free or fee-based from either the updator or updatee direction. Also, if notifications are sent to other nodes that are themselves offline or compromised, the error recovery can ripple through levels of notification. If this happens, RevBots have a overall error recovery for entering a monitoring mode, periodically testing the network, then restart the communication processes once the network seems to be more responsive.

RevBots are installed on other network nodes besides those hosting websites. Here are some examples. When installed on computing platforms of the network backbone, RevBots advantageously reduce network communication bottlenecks, identify and report problem situations and help to thwart hackers. When installed on a company's hub, router, gateway or proxy server, a RevBot advantageously performs filtering, secure e-mailing and other tasks for many or all of the company's workstations.

Another component of the preferred embodiment of the present invention is called a “RevBot Receiver,” an application designed to receive and efficiently process RevBot requests such as those meant to notify a search engine about content changes. A RevBot Receiver is identified with one or more specific search engine computing platforms and can be conveniently located on one of those computing platforms. The RevBot Receiver is not necessary for the present invention to operate, although it does offer several advantages. Programmed to handle communications with RevBots, a RevBot Receiver improves performance by acting as a catalyst for updating the search engine database. The search engine's computing platform can trust its RevBot Receiver to update its database automatically without requiring human intervention. Because good quality security protocols can be built into the RevBot to RevBot Receiver communications, there is no strong need to verify or validate the information. Also, the RevBot Receiver acknowledges the RevBot's communication so that the RevBot does not have need to retransmit its change notification again or to check up on whether the update took effect within the search engine's database, although having the RevBot do so will provide a good double check. With this feature, a RevBot Receiver efficiently takes over some of the functions and obligations of one or more RevBots.

With RevBots, the update to a search engine can be made in only a matter of seconds instead of taking many weeks. Depending on the workload and backlog of a particular search engine, the update time should typically be reduced from several minutes or a few hours. As an example, if the website-to-search-engine update takes only 15 minutes instead of 6 weeks as it was recently measured, the improvement in getting up-to-date content and information to clients is over 2.4 million percent, or 24,192 times faster.

The preferred embodiment of the present invention includes having RevBots provide notifications when small incremental changes occur on the websites with which they are associated. Without a RevBot, if any change is made to a particular website, often the entire website will need to be resubmitted to search engines for update. With RevBots, search engines can be efficiently notified about changes as small as a single web page, a single page element (e.g. text, a graphic, MPEG video, and MP3 audio), or a single website database element.

The scheduling of and the methods used in the update, the retry methods in cases of non-acknowledgements to the update requests along with other RevBot characteristics can be chosen to match the website to the different types of search engines and databases Website characteristics can affect RevBot characteristics such as the website's size, the type of web server, and whether the website is secure or unsecured. Website considerations can affect RevBot characteristics such as other software that may be installed, whether its content is static, dynamic or a combination, and whether the website is topologically located behind a firewall or proxy server. Certain parameters relating a website's configuration to different search engines are known and easily available from search engine submission forms, support documentation, and from the website's web pages, such as through the use of headers and Meta tags on an HyperText Markup Language (HTML) compatible page. These parameters can be preprogrammed into the RevBot application. Alternately, the RevBot can acquire parameters from another network node such as a RevBot Efficiency Server (discussed below). Some of the parameters are advantageously set with the aid of human intervention. Also, in the preferred embodiment, the website administrators or field service technicians can customize and adjust the RevBot settings to optimize its performance.

The invention includes active logic that operates on or in close proximity to that of the website or websites to which it relates. In recent years, computing technology has made it possible to extend the capabilities and features of the computing platform of websites. Being primarily software, the RevBot logic is highly reconfigurable and customizable to suit particular applications. In addition to updating search engine databases and helping to organize a website's contents, RevBots can update other data structures as well as monitor a website for out-of-date references such as broken links to other content and illegal attempts at access. In an alternate embodiment, RevBots can work in conjunction with security and network routing protocols to optimize access for secured information. In this embodiment, RevBots are structured to assist in various kinds of e-commerce and DRM applications.

In still another alternate embodiment of the present invention, the RevBot limits, filters, blocks and enhances website content as it is transmitted over the network. These advantageous features provide to parents and educators the ability to more effectively filter and block undesired content from being viewed by children and teenagers, including sexually explicit and hate related material. Also, such ability is useful generally and commercially to better direct network-related activities such as business transactions. For example, members of a particular industry can use RevBots to ensure that all of the member websites' current content is reflected accurately in the industry's consolidated knowledgebase. By way of another example, a company could use a RevBot to “publish” product data sheets on the network. Through the RevBot, online stores such as Amazon.com and Buy.com would be able to obtain the company's data sheet content in a timely fashion and use it on their own product pages in their own graphical style and format.

This invention can modify the content emanating from the website so as to limit or to enhance the content being provided to a client. This capability has a number of distinct advantages. One example of a RevBot limiting content is a RevBot installed on a website computer platform and used to suppress the addresses on particular web pages of the website containing names, addresses and phone numbers. Another example is a RevBot blocking the entire web page(s) from being transmitted over the network to the client. This last example shows how both data security and personal privacy is enhanced. Also, since the limited, or filtered, content is not allowed by this invention to be transmitted across the network, the network is not burdened with unnecessary, extra traffic.

An example of content enhancement is when a RevBot highlights certain words in a body of text such as in color or using a different font style or it adds links not originally present in the original web page. This feature enhances the web page of the website on which the RevBot is installed, making available to the client additional content and information, and thereby making the client better informed with less effort on the client's part. As another example, RevBots can enhance a web page containing sports teams and game scores with links under the sport team names that take the client to a web page specific to that team, its players, and their statistics.

The preferred embodiments of this invention uses one or more rules which can be either local to or remote from the website's computing platform. For certain rules with extensive look-ups or database-type references, a combination of local and remote rules can be advantageous. By way of specific example, take a restriction to limit the retrieval of certain content except to members of a particular organization. The RevBot rule associated with this restriction can use a database located on a different node that belongs to that organization. Alternatively, for faster processing of incoming client requests, a website's RevBot can utilize its own RevBot Receiver described herein to maintain a local copy of said database. This way, when changes are made to the organization's database, registered nodes including that of the RevBot of this website can be automatically notified and their data files updated.

In the process of determining what content to limit, filter, block or enhance, appropriate algorithms can be used to weigh various factors in determining the appropriateness of website elements. Examples of website elements are web pages, block of texts, graphics, motion picture clips, sound clips and combinations thereof. The result of some of these algorithms can be referred to as a “score.” Depending on whether the score is above or below a certain threshold, access to that web site element is granted. For a finer control of content access, the score can be broken up into different ranges, each range potentially allowing for more or less content to be provided. In this way, the content can be filtered in degrees. The manner in which a score is determined and the threshold can be dependent on the type of data involved and the profile of the intended recipient, commonly an Internet browser user, as perceived by the website's RevBot.

On the client side, a parent may choose to limit a child's access to certain types of content. For example, he or she can have privileged access to a sliding scale which can advance or retard the child's access by some unit measure such as a grade level. The sliding scale on the client side is actually an input to the website's content scoring algorithm that ultimately decides what kind of content is provided back to the client, across the network.

Existing filtering technology can make advantageous use of the present invention. With the RevBot component of the present invention, the website becomes a more discriminating disseminator of content. Existing filter and block standards are supported such as the Platform Internet Content Selection, or PICS. However, the distributed nature of the present invention allows for the formation of more advanced filter and block standards.

Because there is active logic at each participating website, websites similar or related to one another can have similar rules as provided for by governing bodies or controlling entities. An advantage of this consistency provided for by this invention is that common or partial updates to these rules can be made to every registered website quickly and providing for the best possible content management across the network.

RevBots can work on rules established as a collaboration between the website designers and reviewers and evaluators of the website. These rules fill in the rest of the factors for scoring and can determine when to solicit additional input from a human evaluator in order to meet the particular requirements of data organization.

RevBots advantageously administer e-commerce and DRM transactions. Because of the ability of RevBots to influence the response of websites to client requests for content and information, a novel and advantageous structure has been created for promoting network content and for handling payment transactions. With the present invention, a website whose content is available only to registered users or on a payment basis can use RevBots to promote its content in manners previously unavailable. The website and its RevBot can provide a synopsis of its content to search engines along with indications as to how access to the content is granted. Search engine clients can therefore see this additional information that would not have been present before the use of this invention and then decide if accessing the restricted content is worth the effort of registration and/or undertaking a payment transaction. This feature enables search engines to provide more information about what is available on the network, and the search engine's clients can therefore obtain more information about what content and information is available with significantly less effort.

By RevBots enabling search engines to include usually restricted content or information (e.g. synopses of the content), some websites that would, without the use of a RevBot, require users to register and have a local search engine for the restricted content. With a RevBot, some websites will find that either requirements was no longer necessary, thereby saving the cost of maintaining registered users and/or a local search engine. With RevBots, smaller websites with more modest operating budgets will be able to obtain revenue from having search engine clients access their content without the need for a larger website design and operating expense that would be required without RevBots.

By having RevBots participate in the payment transaction process, an improved model of handling transactions is provided. The use of RevBots makes certain websites more visible and provides sales mechanisms such as fee-based content access for selling premium and high-quality content. Websites that before their use of the present invention charged an access fee are advantageously provided with other means for obtain compensation that are more acceptable to clients at large. In other words, while a client may be unwilling to pay, say, $29.95 a month for unlimited access to a news-based website, that same client may be willing to pay, say, $1 to access a particular news article which he might do several times a month. With the present invention, the client can more easily find and then pay for the specific content he is interested in. The website generates additional revenue from new clients provided by way of this invention.

Clients include consumers' personal computers, wireless devices and other consumer-based network equipment such as email readers, e-books, cable boxes, satellite dishes, and telephones. When communicating directly with clients, instead of to network search engines, RevBots enable more secure content delivery in support of DRM. Each personal computer or digital playback unit has a unique identifier built into its microprocessor or other hardware component that can be used by RevBots to uniquely identify the clients network equipment. This way, with RevBots on the transmission side (website) and DRM-aware logic on the receiving nodes (consumer PCs) of a network, a very secure pathway can be achieved for accessing content. For network equipment without unique identifiers, equivalent add-on hardware that plugs into one of the computer's ports or serial-numbered software is used instead.

Also, RevBots allow for an alternate method of distribution, whereby the digital content is provided to consumers on CDs or DVDs, but the authorization method is still over the Internet using the above-described process. This advantage of this method is that the Internet does not have to be used as the delivery mechanism of the content which could be painfully slow especially for full-length feature movie releases. Instead, the Internet is used only for conducting sales transactions and providing access codes to the clients' network equipment. This way, a major motion picture studio could release a number of films on a DVD-like disc, distribute them through the mail or at retail outlets, but require consumers to use DRM to be able to play the movies at home on their computer or video equipment. RevBots tailored to DRM applications also include rules to limit, filter, block or enhance content as described above.

### BRIEF DESCRIPTION OF THE DRAWINGS

FIG. 1 is a block diagram of a typical website without the present invention;

FIG. 2 is a general view of a computer network showing the various components of the present invention including several different arrangements for using the RevBot component;

FIG. 3 is a block diagram of a preferred embodiment of a RevBot constructed in accordance with this invention including a facility to parse incoming requests, filter outgoing responses and to send particular outgoing requests;

FIG. 4 is a block diagram of an alternate embodiment of a RevBot constructed in accordance with this invention that includes a facility to only update remote nodes as changes are made to the website;

FIG. 5 is a diagram of an example instance of the present invention blocking content;

FIG. 6 is a diagram of an example instance of the present invention filtering content;

FIG. 7 is a diagram of an example instance of the present invention enhancing content;

FIG. 8 is a drawing of a client-side control element to adjust the RevBot content filtering, blocking and enhancement operations;

FIG. 9 is a flowchart for a RevBot that processes incoming requests from network clients to access website contents using data and content validation protocols;

FIG. 10 is a flowchart for an alternate embodiment of a RevBot that processes incoming requests from network clients to access website contents without data and content protocols;

FIG. 11 is a flowchart for a RevBot processing incoming requests to update website contents;

FIG. 12 is a flowchart for a RevBot processing incoming requests to update its rules;

FIG. 13 is a flowchart for a RevBot using its notification agent to inform other network nodes about website events;

FIG. 14 is a flowchart for a RevBot using its node processor to detect the presence of other network nodes that might need to be informed about website events;

FIG. 15 is a flowchart for a RevBot Receiver that can be installed at a remote network node to enhance RevBot performance; [“ppa 1 FIG. 15.doc”]

FIG. 16 is a flowchart for RevBot-based e-commerce supporting online fee-based content access; and

FIG. 17 is a flowchart for RevBot-based e-commerce with physical distribution.

It will be seen below that when the same item is shown in separate figures, the same identifying number will be applied to the item.

1) network or Internet

2) clients (aka consumer)

3) Internet access provider

4) online service provider

5) communications link

6) RevBot

6A) alternative RevBot

7) website

8) reverse proxy server

9) website computing platform

10) website computing platform with RevBot

11) multiple website computing platforms with RevBot

12) multiple website computing platforms with multiple RevBots

13) local area network with RevBot proxy server

14) search engine computing platform

15) search engine computing platform with RevBot Receiver

16) RevBot Receiver

17) RevBot Registration File

18) RevBot Efficiency Server

100) network communications layer

101) incoming requests

102) parser

(102A) alternate parser

103) rules change arbiter

104) content change arbiter

105) rules applier

106) rules file

107) access control and deny logic

108) content validator

109) outgoing responses

110) history file

111) notification agent

112) agent outgoing requests

113) agent incoming responses

114) node processor

115) node registration file

116) node outgoing requests

117) node incoming responses

118) external data

119) scorer

120) content change monitor

### DETAILED DESCRIPTION OF THE PREFERRED EMBODIMENTS

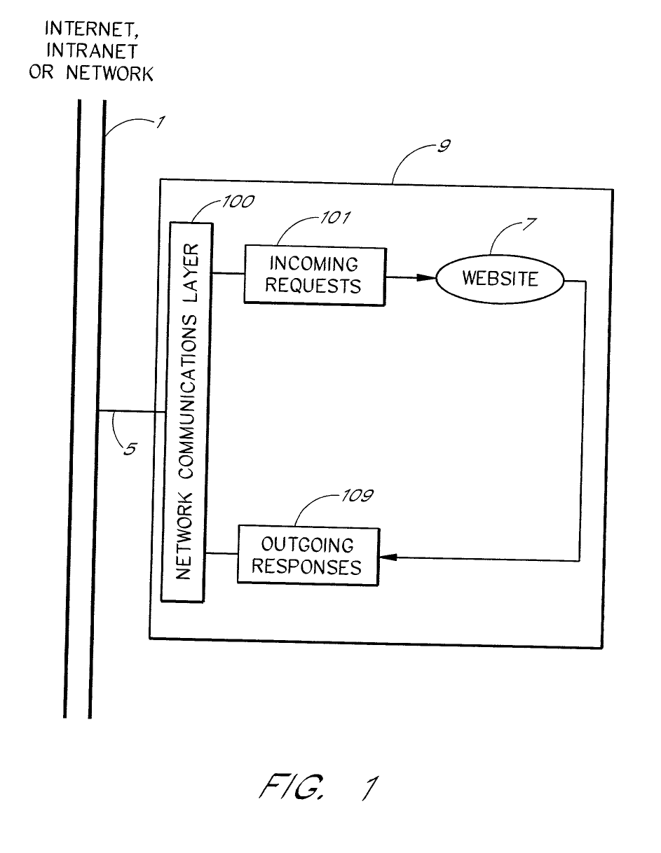

FIG. 1 shows a general view of the present invention in various configurations located on a computer network. The term for one particular component of the present invention is “RevBot,” referring to its primary mode or operating as a reverse search engine robot. Although it performs other tasks, RevBots are designed to enhance existing networks by adding a layer of active logic with a number of additional features to the application logic of a website. RevBots are generally advantageously located in close physical or network topological proximity to the website they serve.

FIG. 1 shows the network topology relationship of a website to a network that does not include the present invention. A computing platform 9 is connected to a network 1 through a communications link 5. On the computing platform 9 is installed a network communications layer 100 and a website 7. The network communications layer 100 is responsible for handling the low-level software and the hardware processing of the computing platform's network interface and in fact can be multiple hardware and software layers in some combination.

The software that operates website 7 is referred to generally as web server software. The website 7 receives incoming requests 101 and responds to them with outgoing responses 109. An example of an incoming request is to view the website's home page. An example of an outgoing response is the HyperText Markup Language, or HTML, content that constitutes the website's home page. The nature of a website's content makes no difference and there are many different forms of content including but not limited to Dynamic HyperText Markup Language or DHTML, Active Server Pages or ASP, JavaScript or JS, Jpeg graphics or JPEG, Graphics Interchange Format or GIF, Mpeg video or MPEG, and RealAudio audio files or RA. The capitalized words are often the file name extension of the file sent in response to a request.

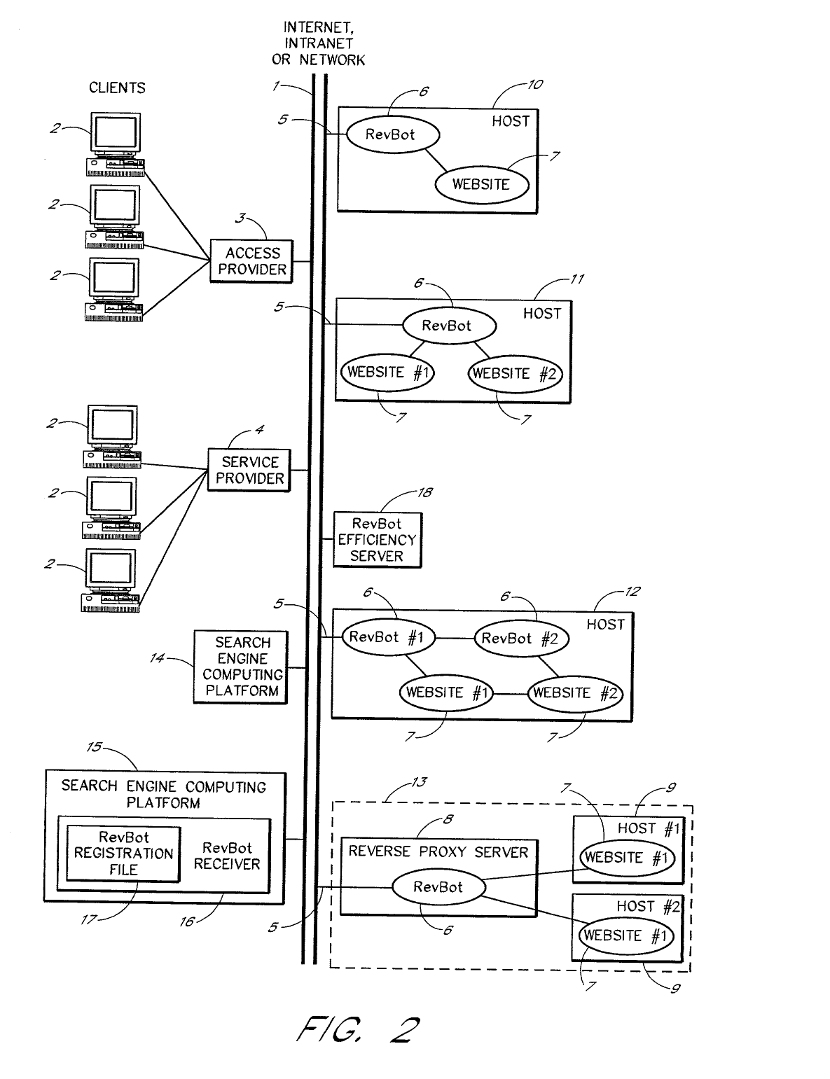

FIG. 2 illustrates several preferred embodiments of the present invention with the installation of RevBot into the network topology of a website. Clients 2 include people browsing on their respective personal computers, wireless devices or other network equipment which accesses the network through their access provider 3 or their service provider 4. In the case of the Internet, the access provider 3 is known as the Internet access provider and the service provider 4 is known as the online service provider. Examples of such providers are America Online (AOL), Earthlink, and Pacific Bell.

A significant feature of the present invention is the RevBot 6. FIG. 2 illustrates that the RevBot 6 is installed in the path of the communications link 5, between the network 1 and their respective websites 7. Because of the complex topology of certain networks, different RevBot configurations can be provided. A simple configuration 10 is where the RevBot 6 is installed between the network 1 and the website 7. In the configuration 11, the RevBot is installed between the network and multiple websites. Another configuration 12 is used for a shared website computing platform where multiple RevBots 6 work with respectively multiple websites 7. A configuration 13 is used when websites 7 and their computing platforms 9 are located behind a firewall or a proxy server 8. Other configurations are possible such as installing RevBots in series (not shown) to perform more complex tasks or to accomplish tasks within a shorter period of time.

Shown in FIG. 2 is a search engine computing platform 14 which represents the computing platform of an existing search engine. FIG. 2 also illustrates a novel search engine computing platform 15 including a component of the present invention, the RevBot Receiver 16. As described in detail below, the RevBot Receiver 16 enables its associated search engine computing platform to respond more quickly to and process incoming communications from network RevBots. In the embodiment shown, the RevBot Receiver 16 contains a RevBot registration file 17 or a reference to similar data for the purpose of forwarding changes of the associated database node to particular RevBots, again as a means to speed up the update cycle. Also shown is the RevBot efficiency server 18 that enables RevBots to be tied together such as by supporting a custom topology or by maintaining a centralized repository of content or information.

It should be noted that although the term search engine is used throughout this disclosure, this invention is applicable to cover network nodes in general that contain one or more references to a website 7 imbued with a RevBot 6. Search engines are common examples of such nodes, and our referring to them specifically herein is meant in the form of a clarifying example.

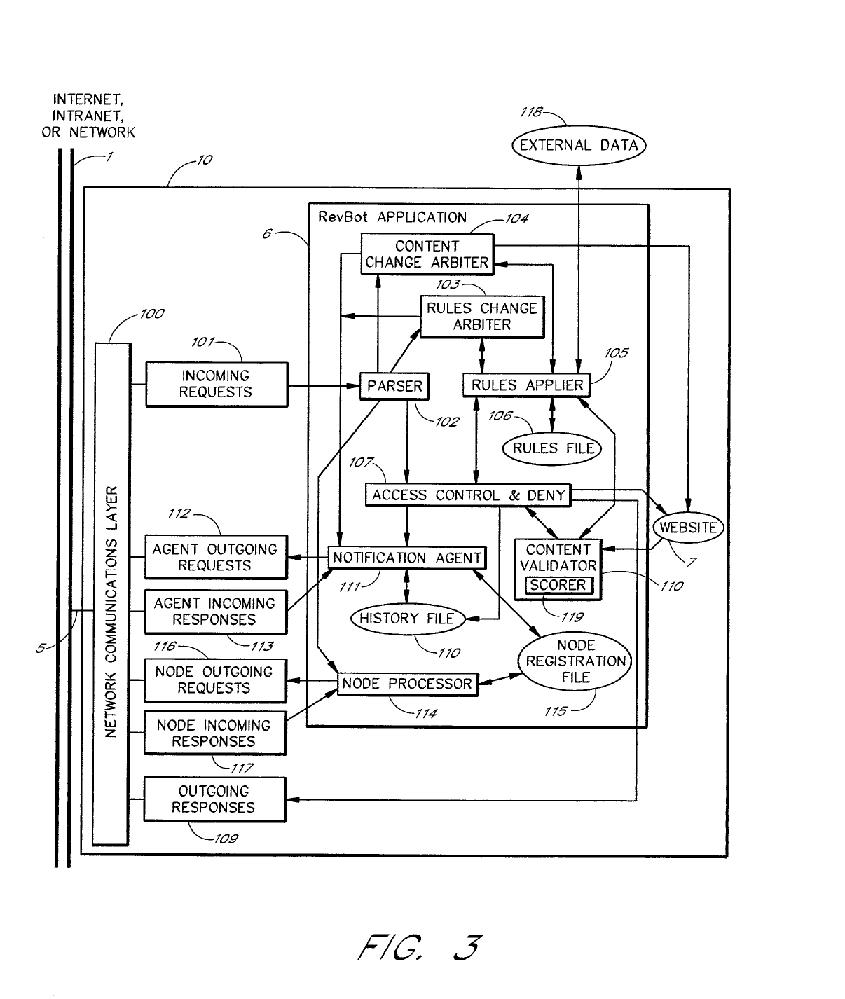

FIG. 3 shows the key elements of a preferred embodiment of the RevBot component of the invention. Again, the website computing platform 10 is connected to the network 1 by a communications link 5. Although the computing platform 10 with a single RevBot configuration is shown, other configurations will be apparent including computing platforms 12 and 13 (see FIG. 2). Since the RevBot 6 is from a topological standpoint placed in between the network 1 and the website 7, the RevBot 6 can be conveniently located on the same computing platform as that for the website. As with any typical networked computing platform, there is a network communications layer 100.

RevBot 6 includes a parser 102 for monitoring incoming requests 101 coming from the network 1 across the communications link 5 and through the network communications layer 100. The RevBot 6 affects otherwise the normal request and response behavior of the website 7 based on a set of rules stored in a rules file 106 and optionally based on external data 118. External data 118 is any other data used in the processing of rules that is not located in the RevBot's rules file 106 and can be on another network node or computing platform. One example of such a condition is when the external data 118 constitutes a database with useful data for applying RevBot rules that may be more conveniently maintained elsewhere, possibly topologically centralized so that multiple RevBots could reference the database concurrently. For more efficient processing of incoming client requests, a website's RevBot can maintain a local copy of said database. When changes are made to the external data 118, this RevBot rules applier 105 can be notified and have its rules file 106 updated to be in synchronization.

The rules in the rules file 106 and from external data 118 are used by the rules applier 105 to determine whether to grant or reject the requested access to content and information. Examples of such rules are:

1. Only allow access from particular nodes

2. Only provide access during certain hours of the day

3. Only allow access from registers users using a security key

4. Only allow access from within a particular geographic region

5. Only allow access with the receipt of payment or credit approval

6. Transmit notifications, if any, to a particular node at only certain intervals

In each of these cases, the implied additional parameters such as which nodes from which to allow access or which time zone to base the hours on are all part of the rules file. Note that the rules file is a logical construct that refers to a complete set of rules to which the RevBot has access and, as such, the rules, their parameters and any other supporting data may actually be stored in memory, a number of physically separate files or a combination thereof. In some embodiments of the invention, it may be more convenient to have a list of allowable nodes or registered uses to be kept in a separate file maintained by database applications. In other embodiments, a list of rules can be maintained on or in any convenient computing form or apparatus, such as in memory or on multiple storage devices.

The rules applier 105 feeds the access control and deny logic 107 that is the element that controls access of the website contents by the source of the incoming requests 101 or denies it completely. In the case that the access control and deny logic 107 denies access completely, the access control and deny logic 107 will advantageously construct an outgoing response 109 with an appropriate denial message instead of with the actual requested website contents.

Should the access control and deny logic 107 determine that access to the content is warranted, it then passes the data of the incoming request 101 to the website 7 and instructs the content validator 108 to review the response from the website 7. Without this invention (FIG. 1), the data of the response generated by the website 7 is that which is transmitted through the network communications layer 100 and transmitted over the network 1. With this invention, the data of the response generated by the website 7 is reviewed by the content validator 108. If the content validator 108 detects that the content is invalid, such as might be the case if a hacker tampered with the website's content, it communicates this detection to the access control and deny logic 107 which can then treat the condition based on rules applied by the rules applier 105. One of the steps for validation can be a digital signature of the contents that is compared to an earlier known-to-be-valid copy. Typically, in such a case as invalid website content, the access control and deny logic 107 will deny the associated incoming request 101 so that the tampered content will not be transmitted out over the network 1. Here, the access control and deny logic 107 can advantageously construct an outgoing response 109 with an appropriate denial message instead of with the actual requested website contents.

The rules in the rules file 104 can be either preprogrammed or defined and modified at any time by website administrators. Updating the rules file 106 is accomplished via particular incoming requests 101 that are identified by the parser 102 as RevBot related commands and directed towards the rules change arbiter logic 103. The rules change arbiter 103 checks the validity of the requested change and looks for any reasons to deny the change such as a conflict with another rule. Website administrators provide the incoming requests 101 for rule changes from some other node on the network 1 or through a user interface on the website's computing platform (not shown).

In a similar manner, updating the contents of a website 7 including any of its executing code is accomplished via particular incoming requests 101 that are identified by the parser 102 as website change related commands and directed towards the website change arbiter 104. The website change arbiter 104 checks the validity of the requested change and looks for any reasons to deny the change such as a request with an invalid security key or a conflict with a particular rule. Website administrators provide the incoming requests 101 for website changes from some other node on the network 1 or through a user interface on the host computing platform (not shown).

The notification agent 111 enables other nodes on the network 1 to be alerted when (a) a rules change is processed by the rules change arbiter 103, (b) a content change is processed by the content change arbiter 104, (c) the access control and deny logic grants or denies access, or (d) the content validator 108 detects invalid content. The notification agent 111 uses a node registration file 115 that contains a list of node network locations to construct and transmit agent outgoing requests 112. The agent outgoing requests 112 contain the information or a pointer to the information about the event that triggered the notification agent 111. The notification agent 111 then awaits agent incoming responses 113 that acknowledge receipt by the intended node. Should the notification agent 111 not receive a properly formed agent incoming response 113 to a particular agent outgoing request 112, notification agent 111 enables common error recovery and timeout procedures known in the art such as waiting a period of time followed by another attempt to retransmit the agent outgoing request 112. The notification agent 111 handles multiple agent outgoing requests 112 and monitors for corresponding agent incoming responses 113 independent of one other. Also, the notification agent 111 transmits to different subsets of the network nodes registered in the node registration file 115 depending on the nature of the notification agent 111 trigger and other parameters.

When the access control and deny logic 107 and the notification agent 111 take certain actions, these actions are logged to a history file 110 for subsequent review and fee collection. Note that actions taken by the content validator 108 can also be logged in the history file 110 since the content validator works in conjunction with the access control and deny logic 107. Sections of the history file 110 can be viewed locally, on the website's computing platform, or they can be transmitted to a remote node on the network 1. This can be accomplished either through a particular kind of agent incoming response 113 or by a specific incoming request 101 that is detected by the parser 102 that is relayed to the access control and deny logic 107 which then instructs the notification agent 111 what to transmit.

The data from one or more sections history file 110 can be processed, producing reports such as those used for monitoring network and website access and performance, and being integrated into an accounting system (not shown) for billing and fee collection purposes. The accounting system can be linked to more that one RevBot providing a combined accounting process. It can also employ RevBots to communicate with other accounting systems in a distributed model such as that which might be used between companies in the same marketplace.

The node processor 114 is responsible for maintaining an up-to-date node registration file 115, accomplished by the node processor 114 scanning the network for qualifying nodes. The node processor 114 transmits node outgoing requests 116 over the network 1 and receives in response node incoming responses 117. Also, the node processor can be instructed to add particular nodes directly to the node registration file 115 through a special incoming request 101 that is detected by the parser 102 and then relayed to the node processor 114. A list of nodes can be maintained on or in any convenient computing form or apparatus, such as in memory or on multiple storage devices.

The content validator 108 limits, filters, blocks and enhances content as it passes from the website 7 to transmission over the network 1. Within the content validator 108 is the scorer 119 that analyzes the content and, with or without the application of rules, determines the type, scope and method of the filtering, blocking, and enhancement. The analysis of content can take many forms most of which are based on computer science and mathematics and are well known and practiced in the art.

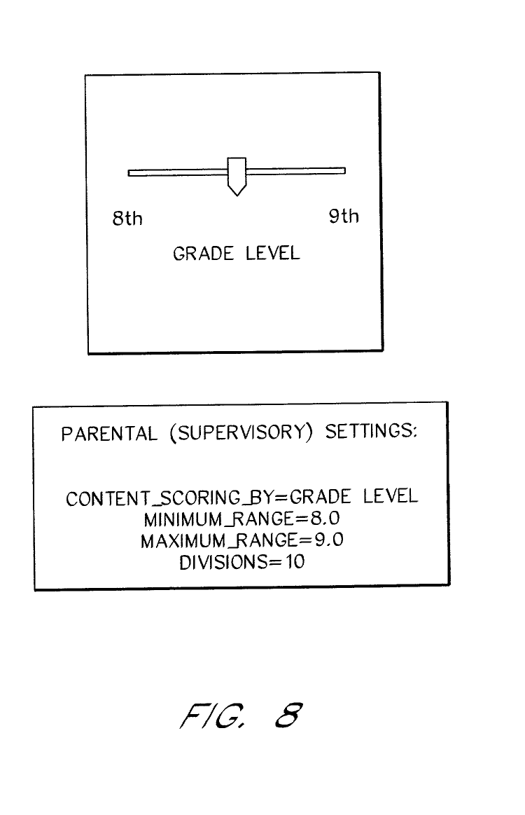

Influencing how the content validator 108 and the scorer 119 operate is data coming from or defined by the client. This data, called a profile, header or signature, is used to more accurately perform the content filtering, blocking and enhancement operations. For example, the types of operations to be performed for a university professor are different than those for a grade school student. For improved security, this data can be transmitted encrypted or with other security features. In one embodiment of the invention described below and shown in FIG. 8, a specialized graphical user interface or GUI enables a sliding scale control on the client side to adjust the filtering, blocking and enhancement operations.

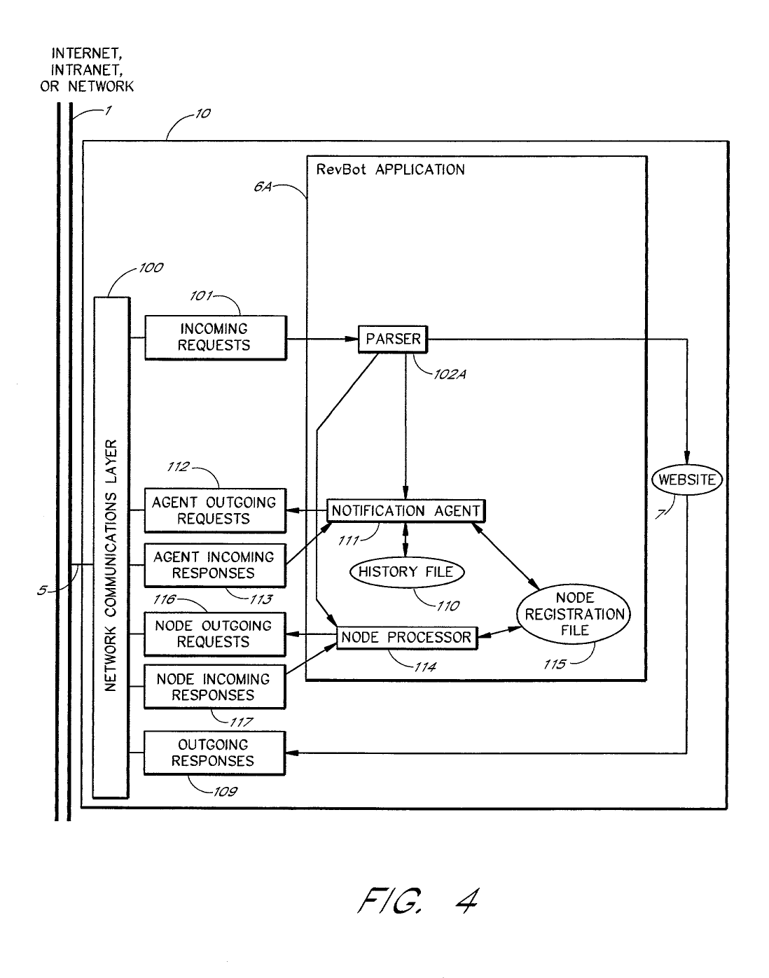

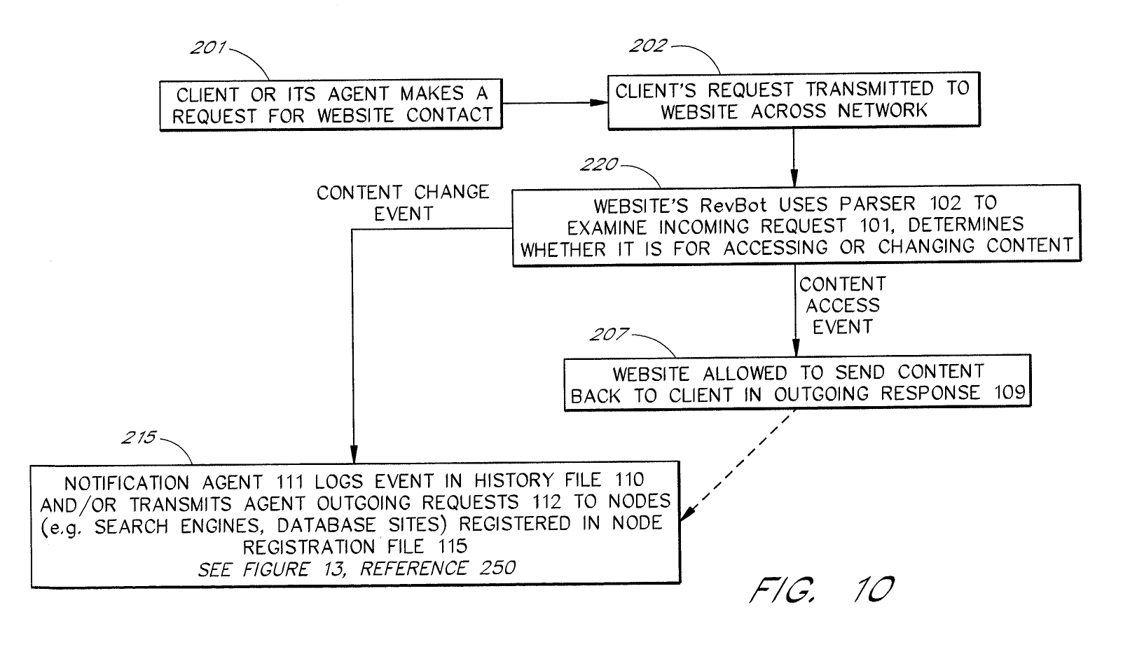

FIG. 4 shows an alternate embodiment of the invention in which a simplified RevBot 6A is used to provide the basic operation of updating other nodes when the contents of the website with which RevBot 6A is associated change. By way of specific example, this simplified RevBot 6A is useful for managing a vast array of relatively simple websites such as thousands of personal pages for an Internet Provider such as Earthlink and AOL. When compared to FIG. 3, it is seen that References 103 through 108 and 118 are missing since RevBot operations relating content change, blocking, filtering and enhancements do not apply in this embodiment. Instead of the content change arbiter 104 (FIG. 3), it is the parser 102A in RevBot 6A that triggers the notification agent 111 to send out content update notifications to search engine and other database nodes. FIG. 10 is a flowchart that also pertains to this alternate embodiment.

The elements that make up RevBots 6 and 6A and shown in the block diagrams of FIGS. 3 and 4 have been described conceptually so as to make clear the functionality and operation of RevBots. These various elements include items number 100 through 120 such as the parser 102, the rule change arbiter 103, the content change arbiter 104. the rules applier 105, the access control and deny logic 107, the content validator 108, and the notification agent 111. In developing a computer application, it is common practice to combine and distribute the functionality of these elements across one or more computing logic groups to best match the architecture of the computing platform, its hardware, supporting software, communications and networks. By way of specific example, the access control and deny logic 107 may very easily be combined with the logic for the rules applier 105 and the content validator 108. Another example is the splitting up of the notification agent 111 over more than one computing platform where one platform is used by the RevBots 6 and 6A to develop notifications while another platform is used to manage the transmission of the agent outgoing requests 112 and the reception of corresponding agent incoming responses 113. Another similar example would be that which relates to the node processor 114 and the handling of node outgoing requests 116 and node incoming responses 117.

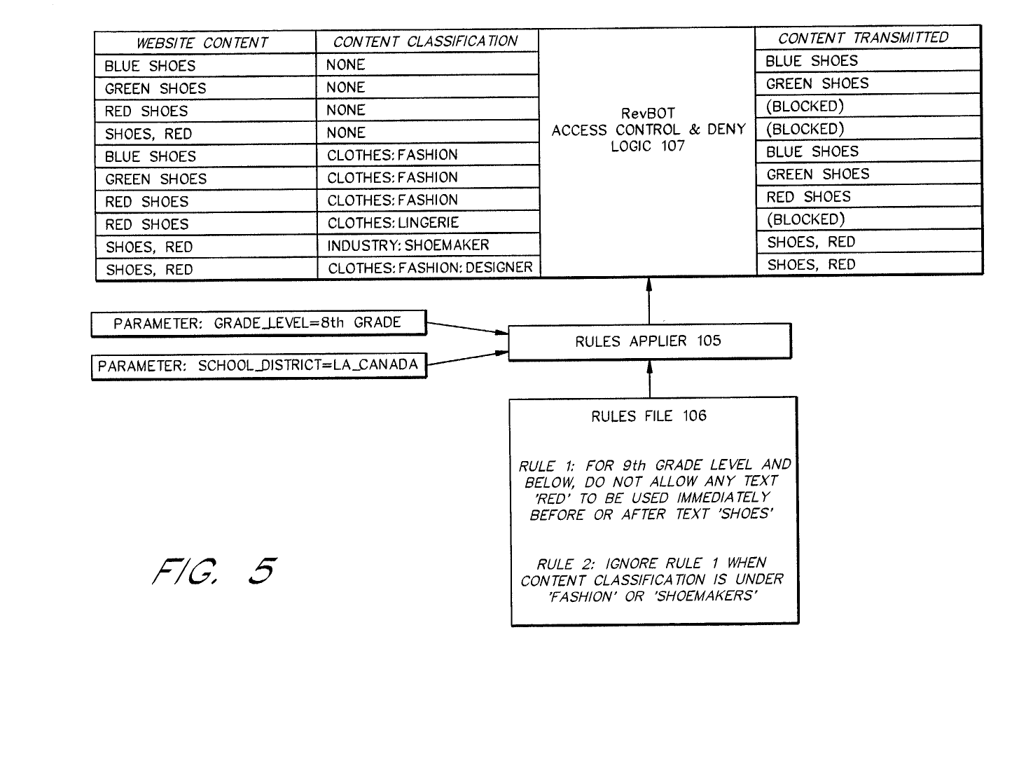

FIG. 5 shows an example of the present invention blocking content where certain content that meets particular rules is prevented from being transmitted to the client. In this example, Rule 1 is to block content of text “red” used immediately before or after the text “shoes” for the 9th grade level and below. Rule 2 is to ignore Rule 1 when the content's classification, if one is defined, is listed under the categories “fashion” or “shoemakers.” These examples of rules are used to demonstrate the RevBot content blocking operation. Actual rules will ordinarily be more complex and use any data, algorithm or analysis deemed useful by the website administrators and their programmers. The parameters in the example define a “Grade_Level” parameter of “8th Grade” which is used to activate the blocking by Rule 1 and a “School_District” parameter of “La Canada” which is not used. Parameters, too, can be of any construct, and not all parameters need to be processed by the rules applier 105 nor do all parameters defined in the rules file 106 need to be defined. The rules applier can utilize default values for parameters as is done in most computing applications that accept parameters. In cases of the blocking of entire web pages, an informative message such as a substitute web page that describes the block can be transmitted instead.

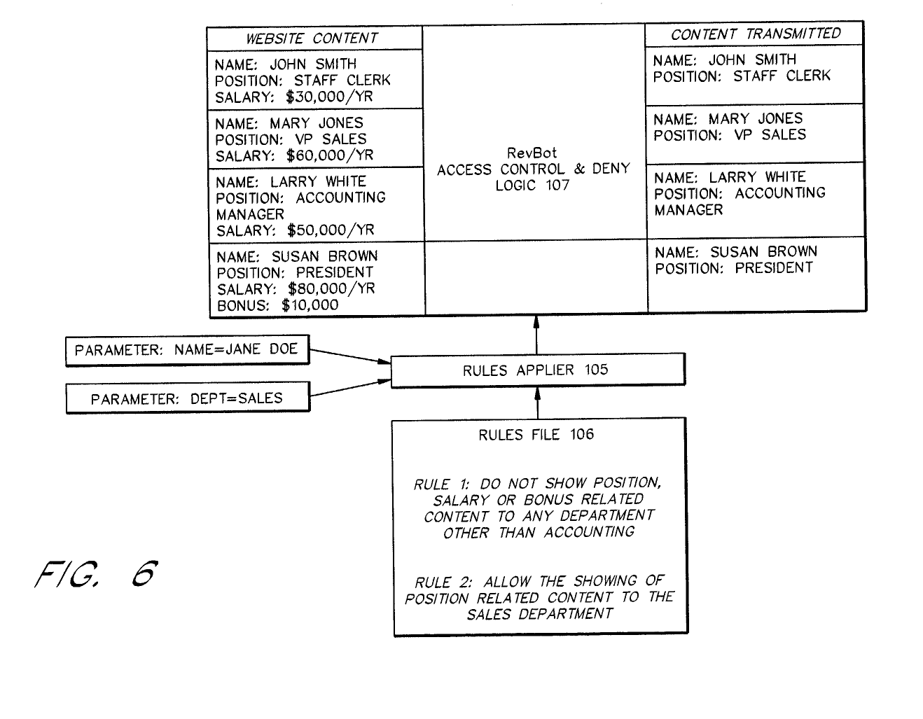

FIG. 6 shows an example of the present invention filtering content. While all of the content is transmitted to certain clients, certain content is not transmitted to particular clients based on their profile. In this example, Rule 1 restricts the transmission of position, salary and bonus related content to any department other than accounting. Rule 2 reinstates the transmission of position related content if the incoming request 101 is identified by parameter “Dept” as coming from “Sales.” Since this is the case, the content that is transmitted including the position related content but not the salary or bonus related content. Although the “Name” parameter is not used by the rules in this example, it could be passed along to the notification agent 111 for possible use such as for making an entry to the history file 110.

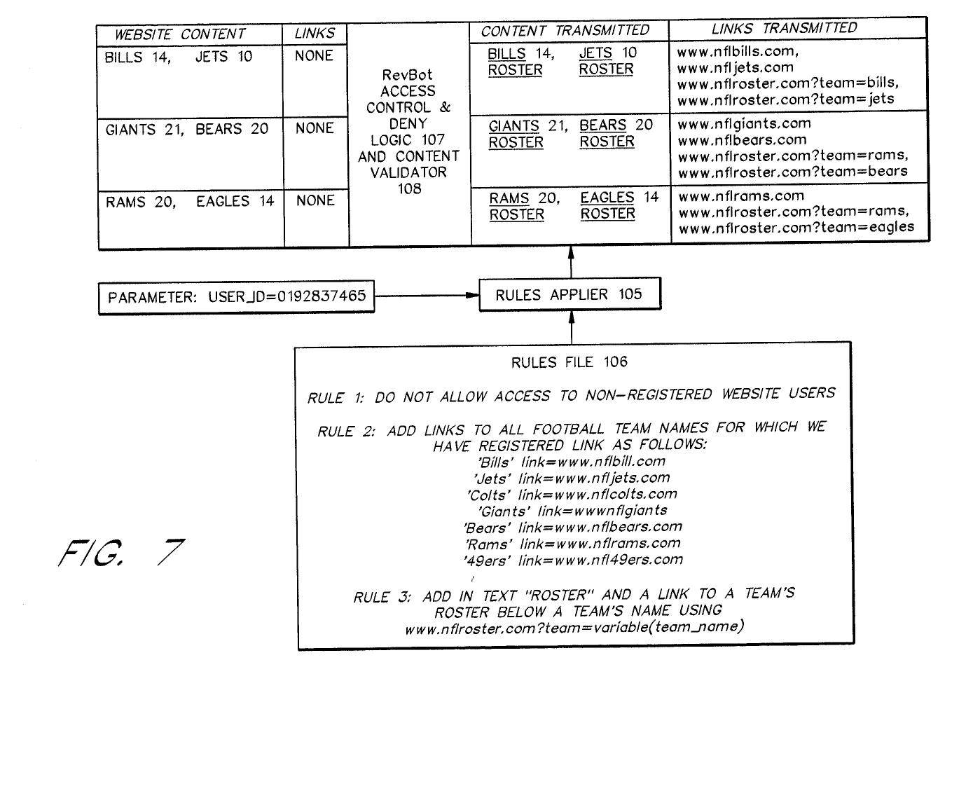

FIG. 7 shows an example of the present invention enhancing content. Note that certain content is enhanced as set forth in or by the rules file 106. Similarly, certain content can be enhanced as set forth in or by external data 118 shown in FIG. 3. Rule 1 restricts access of content to registered users, a parameter maintained by the example website. In this case, the “User_ID” parameter is defined and verified using methods well known in the realm of network access, so no blocking is triggered by Rule 1. Rule 2 adds links to certain texts, in this case, football team names. The underlined content shown in the Content Transmitted Column of FIG. 7 refers to the respective links listed in the Links Transmitted Column. Whereas, in the original content, the football game score was simply reported as “Bills 14, Jets 10,” with the RevBot enhanced content transmitted over the network, the client clicking on “Bills” links to the Bills website and “Jets” to the Jets website. Under each of these team names is the added text link “Roster.” When the client clicks on one of these added links using well-known means, a new web page of the respective team's roster is provided. Note that the “Roster” link in this example uses a computed formula to determine the proper link destination URL. For the purpose of error trapping, additional rules can be defined as to what should happen if any of the links failed to operate.

In all three examples of FIGS. 5 through 7, the type of messages returned to the client and what kind of notifications, if any, are sent by the notification agent 111 are determined by the type of filter, block or enhancement operation performed and the client's profile. This allows only certain types of useful information to be collected without wasting network resources, compromising network security, and endangering personal privacy by unnecessarily transmitting data over the network that will eventually be filtered out on the client side anyway.

Referring to FIGS. 3 and 4, incoming requests 101, agent incoming responses 113, and node incoming responses 117 are handled effectively the same by the network communications layer 100 and passed through to the RevBot 6 which will make its own determination as to the nature of the communication. Likewise, outgoing responses 109, agent outgoing requests 112, and node outgoing requests 116 are advantageously treated the same by the network communications layer 100. They are broken out in this disclosure and its accompanying figures for purposes of clarity.

The various request and responses can use one or more standard formats well known in the network community, thereby promoting RevBot standardization and ease-of-use. For example, the Extensible Markup Language, or XML, can be used so that RevBots and search engines with which they communicate are enabled to make automatic or semi-automatic determinations as to what information is available and required for their processing. Depending on the rules, a semi-automatic determination can involve a person (e.g. by phone, by email) who would then be in a position to evaluate the situation and complete or help complete the determination.

FIG. 8 shows a sliding scale control for the client side used to adjust the content limiting, blocking and enhancement features of the present invention. This control enables parental or supervisory control to define the method of content scoring and set the allowable range of the adjustment, from coarse to fine increments or both. The upper portion of FIG. 8 shows the perspective by a student. Thus, for example, a student halfway through the 8th grade may be allowed to retard to a minimum of a pure 8th grade level or advance to a maximum of a 9th grade level in increments of 1/10 grade levels. The setting of the control as shown is set halfway between the 8th and 9th grade levels representing the normal level of the student in this example, or, for the purposes of our description here, a grade level of “8.5”.

In the example shown, the parental or supervisory control has set the RevBot's content scoring to be by grade level, have a minimum range of 8.0 representing pure 8th grade, have a maximum range of 9.0 representing pure 9th grade, with 10 divisions. Internally, the grade level value is translated to a format recognized by the system computer, transmitted along with any other parameters and in the incoming request 101 to a website's RevBot 6. The RevBot 6 then uses these parameters in its rules applier 105, access control and deny logic 107, content validator 108 and scorer 119 to perform the corresponding filter, block and enhance operations. In the example, the use of a grade level as the method by which content scoring is performed is completely arbitrary. Any other method or a combination of methods can be used that the RevBot has been set up to recognize. It should be understood that the present invention is not limited to any precise representation, human interface, or human concept of the control.

### Operation of the Preferred Embodiments of the Invention

As described above, the RevBots 6 are associated with individual network nodes including websites, the RevBot Receiver 16 associated with search engine and other database-related network nodes, and the RevBot Efficiency Server 18 is associated with plural RevBots, especially across a complex network topology such as the Internet.

RevBot 6 Operation

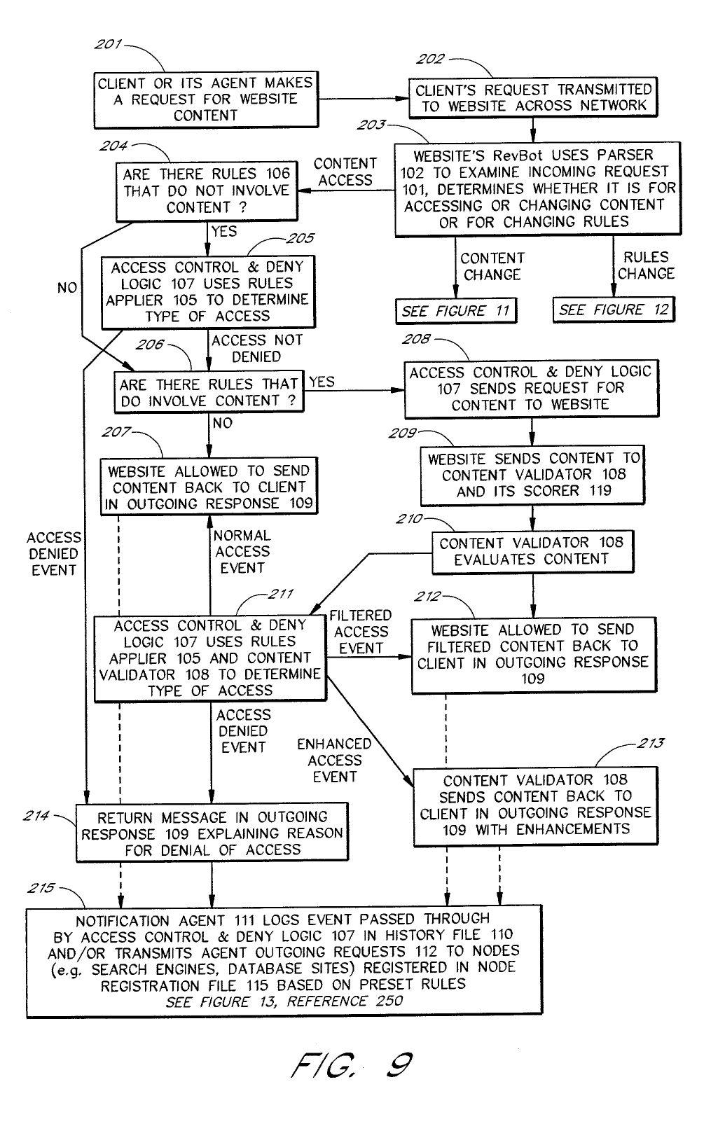

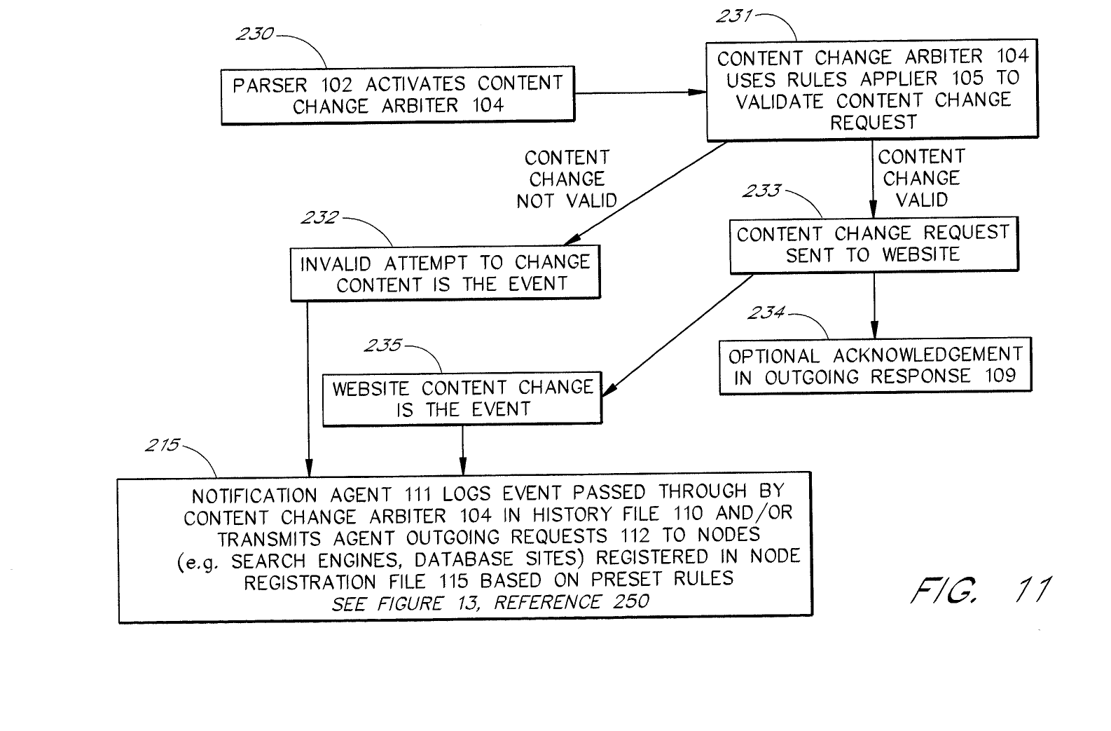

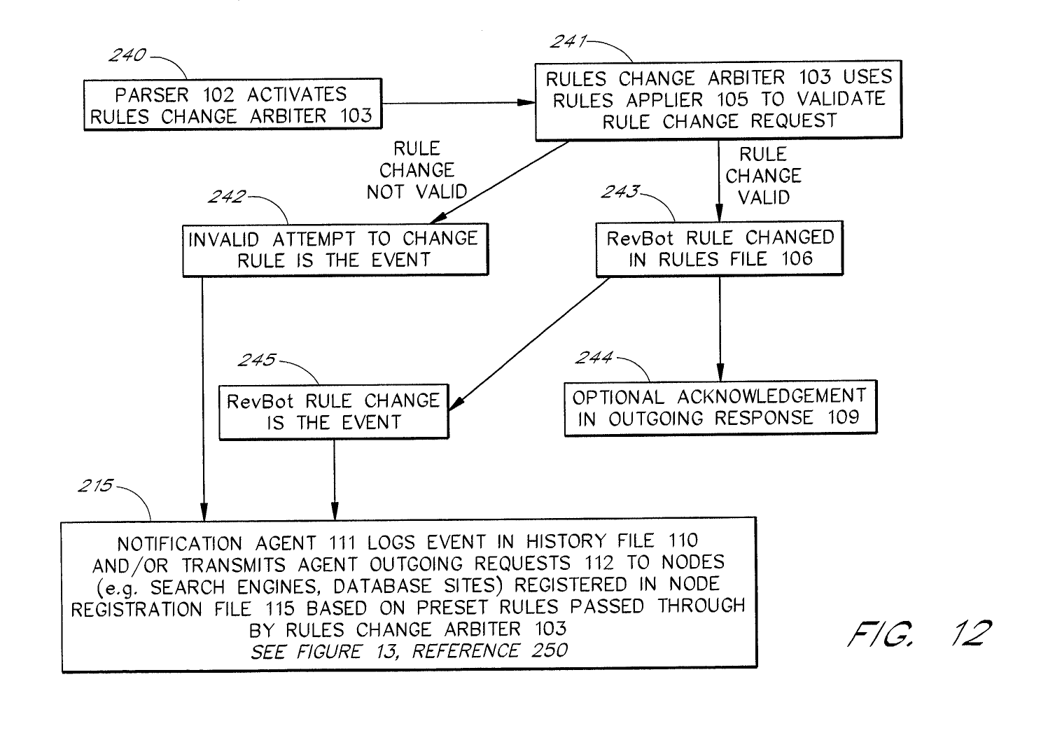

FIG. 9 is a flowchart showing the operation of the preferred embodiment of the RevBot component of the present invention shown in FIG. 3. As shown in Reference 201, client 2 or its agent makes a request for content from a website 7. By way of specific example, a client may be a consumer who uses his or her personal computer as the client 2. Then, in Reference 202, Client's request transmitted to website across the network. At reference 203, the Website's RevBot uses Parser 102 to examine Incoming Request 101, determines whether it is for accessing content, accessing rules, changing content, or for changing rules. If the Incoming Request 101 is for content change, the parser hands off the analysis to the Content Change Arbiter 104 as discussed below with FIG. 11. If the Incoming Request 101 is for a rules change, the parser hands off the analysis to the Rules Change Arbiter 103 as discussed below with FIG. 12.

Once it has been determined that the request is for accessing content, the Access Control and Deny logic 107 begins its analysis. As shown in Reference 204, it asks if there are rules 106 that do not involve content. If after a review of the Rules File 106 or External Data 118 the answer is yes, then, in Reference 205, the Access Control & Deny logic 107 uses Rules Applier 105 to determine type of access to provide to the client 2.

If there were no rules 106 that did not involve content, or if, in Reference 205, access was not denied, then the Access Control & Deny logic 107 asks, in Reference 206, if there are rules that do involve content. If after a review of the Rules File 106 or External Data 118 the answer is no, then, as shown in Reference 207, the website 7 is allowed to send content back to client 2 in Outgoing Response 109.

If the answer is yes, then, as shown in Reference 208, the Access Control & Deny logic 107 sends the request for content to the website 7. In response, in Reference 209, the website 7 sends back the corresponding content to the RevBot's Content Validator 108 and its Scorer 119, where, in Reference 210, the RevBot's Content Validator 108 evaluates this content. Again, in Reference 211, the Access Control & Deny logic 107 uses Rules Applier 105 and Content Validator 108 to determine the type of access to provide to the client 2.

If it is determined that the type of access is a Normal Access Event, then, as shown in Reference 207, the website 7 is allowed to send content back to client 2 in Outgoing Response 109. If it is determined that the type of access is a Filtered Access Event, then, as shown in Reference 212, the website 7 is allowed to send filtered content back to client in Outgoing Response 109. If it is determined that the type of access is an Enhanced Access Event, then, as shown in Reference 213, the Content Validator 108 sends content back to the client 2 in Outgoing Response 109 with enhancements. If it is determined that the type of access is an Access Denied Event, then, in Reference 214, a return message explaining reason for denial of access is provided in Outgoing Response 109.

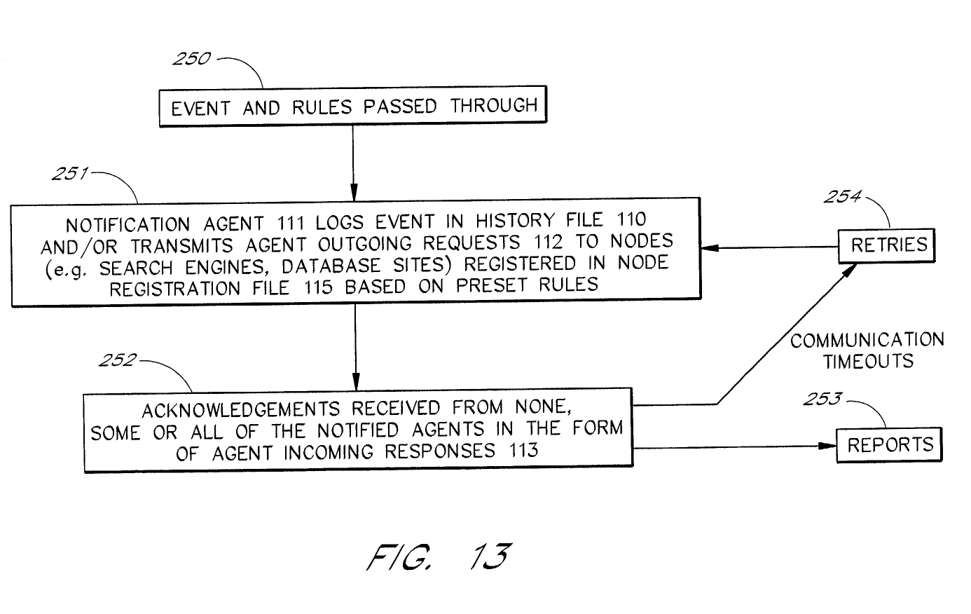

As will be discussed in more detail below with regard to FIG. 13, as shown in Reference 215, any of these events can have the RevBot's Notification Agent 111 log the event in the History File 110 and have Agent Outgoing Requests 112 transmitted to nodes (e.g. search engines, database sites) that are registered in the Node Registration File 115 based on preset rules passed through by Access Control & Deny logic 107. It should be noted that the events detailed in References 207, 212 and 213 can also trigger operation of the notification agent (dashed lines).

RevBot 6A Operation

FIG. 10 shows a flowchart of an alternate embodiment of the RevBot 6A showing the basic operation of updating nodes when the website's contents change. This embodiment is useful for managing a vast array of relatively simple websites such as hundreds of thousands of home pages for AOL members. When compared to FIG. 9, it is seen that References 203 through 206 and 208 through 214 are missing since RevBot operations relating to content change, blocking, filtering and enhancements do not apply. Instead, as shown in Reference 220, a Content Change Event is used to trigger optional operation of the Notification Agent 111.

Changes to Website Contents

FIG. 11 is a flowchart illustrative of how a RevBot 6 updates the contents of a website 7. As shown in Reference 230, the Parser 102 activates the Content Change Arbiter 104 (see FIG. 3). Then, in Reference 231, the Content Change Arbiter 104 uses the Rules Applier 105 to validate the content change request. This validation process includes the validation of the client, the network routing, and the request using data encryption and security methods such as those well known to those who work with computer networks. If the content change is deemed invalid, then, in Reference 232, an invalid attempt to change content is the event, and the Notification Agent is activated in Reference 215.

Otherwise, if the content change is deemed valid, then, as shown in Reference 233, the content change request is sent to the website or websites associated with the RevBot 6 (see FIG. 2) in Reference 234, an acknowledgement is optionally transmitted back to the client in Outgoing Response 109, and, in Reference 235, the website content change is the event, and the Notification Agent is activated in Reference 215.

In Reference 215, the RevBot's Notification Agent 111 logs event in History File 110 and/or transmits Agent Outgoing Requests 112 to nodes (e.g. search engines, database sites) registered in the Node Registration File 115 based on preset rules passed through by Content Change Arbiter 104 (see Reference 250 in FIG. 13).

Changes to RevBot Rules

FIG. 12 is a flowchart of how a RevBot 6 updates its operating rules. As shown in Reference 240, the Parser 102 activates the Rules Change Arbiter 103. Then, in Reference 241, the Rules Change Arbiter 105 uses the Rules Applier 105 to validate the rules change request. The validation process, as above, includes the validation of the client, the network routing, and the request using data encryption and security methods such as those well known to those who work with computer networks. If the rules change is deemed invalid, then, in Reference 242, an invalid attempt to change rule is the event, and the Notification Agent is activated in Reference 215.

Otherwise, if the rule change is deemed valid, then, as shown in Reference 243, the rule change is made to the Rules File 106, in Reference 244, an acknowledgement is optionally transmitted back to the client in Outgoing Response 109, and, in Reference 245, the rule content change is the event, and the Notification Agent is activated in Reference 215.

In Reference 215, the RevBot's Notification Agent 111 logs event in History File 110 and/or transmits Agent Outgoing Requests 112 to nodes (e.g. search engines, database sites) registered in the Node Registration File 115 based on preset rules passed through by Rules Change Arbiter 103 (see Reference 250 in FIG. 13).

Notification Agent 111 Operation

FIG. 13 shows the operation of a RevBot's Notification Agent 111. As shown in Reference 250, a particular event and any associated rules are passed through to the Notification Agent 111. Then, in Reference 251, the Notification Agent 111 logs a record of the event and the time and location it occurred in the History File 110. Also, the Notification Agent 111 transmits Agent Outgoing Requests 112 to nodes (e.g. search engines, database sites) registered in the Node Registration File 115 based on the rules passed through.

As shown in Reference 252, acknowledgements received from some or all of the notified agents come in the form of Agent Incoming Responses 113. If a period of time elapses without a response from a particular node, a communication timeout occurs, and, in Reference 254, a communications retry occurs. This process can repeat itself until the node responds or a certain number of reties occur at which point the Notification Agent 111 follows recovery rules well known in the area of network communications. For example, the notification can be rescheduled until some future time or another network node can be informed as to the inability to communicate, that node invoking an appropriate action. In Reference 253, reports can be generated for viewing by website and network administrators to evaluate and adjust the Notification Agent 111 performance.

Node Processor 114 Operation

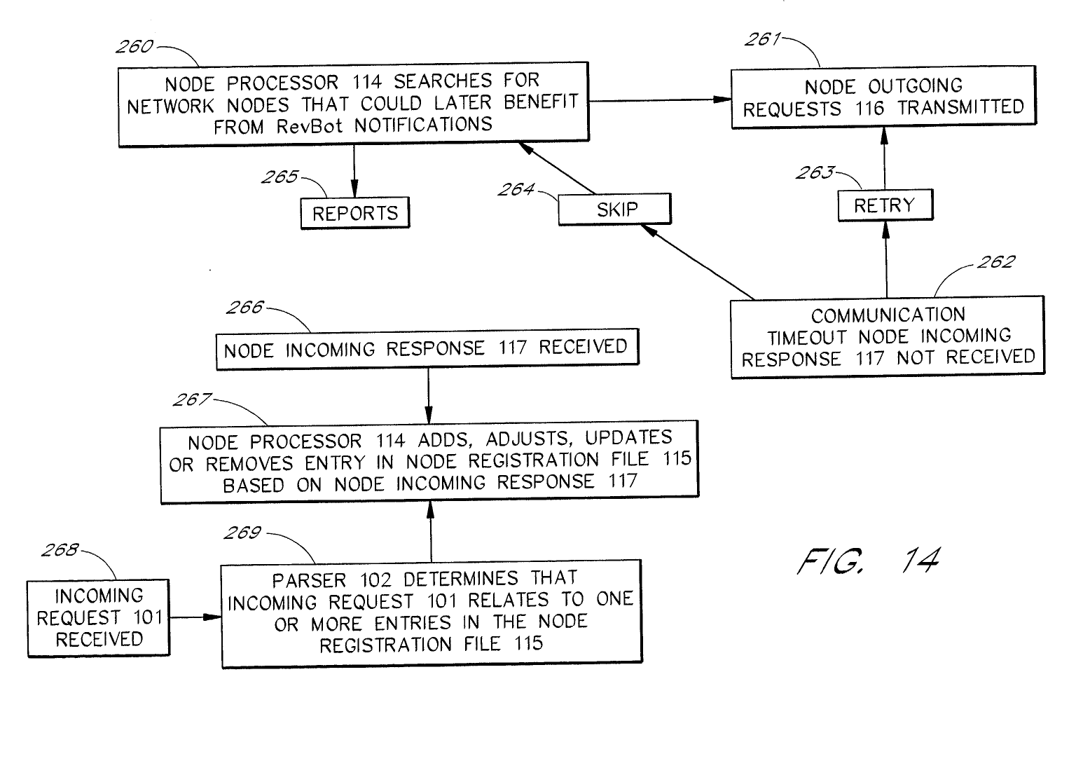

FIG. 14 shows the operation of a RevBot's Node Processor 114. As shown in Reference 260, the Node Processor 114 searches for and maintains a list of network nodes that can later benefit from different types of RevBot notifications. Examples of such nodes are search engine computing platforms and computing platforms on which databases of network locations are maintained. The method of searching and maintenance are well known in the network community and include scanning network address for qualifying nodes and looking up nodes from a database.

For any particular node, in Reference 261, a Node Outgoing Request 116 is transmitted over the network. Within a particular preset period of time, the Node Processor 114 expects to receive a response in the form of a Node Incoming Response 117. If no such response is forthcoming, then, in Reference 262, a communication timeout occurs. In References 263 and 264, retries occur and, eventually, a skip to the next node occurs. Lists of prospect nodes can be downloaded from other locations such as from the RevBot Efficiency Server 18 (see FIG. 3) as a source for the nodes to be scanned and maintained. In a manner of multitasking and parallel processing, Multiple Node Outgoing Requests 116 can be transmitted with the Node Processor 114 waiting for multiple responses. In other words, there is no requirement that the Node Processor 114 has to wait for a response from a particular node before continuing its searching or maintenance of other nodes. In Reference 265, reports can be generated for viewing by website and network administrators to evaluate and adjust the Node Processor 114 performance.

Reference 266 shows that a Node Incoming Response 117 has been received. The Node Processor 114, in Reference 267, then adds, adjusts, updates or removes entry in Node Registration File 115 based on the response received.

In addition to searching for and maintaining a list of nodes, Node Processor 114 can take unsolicited commands from Incoming Requests 101, in Reference 268, to perform these same functions. For example, the RevBot Efficiency Server 18 can transmit a request to all RevBots to change the URL of a search engine computing platform 14. As another example, a particular client 2 can make a secure request to make a change in the Node Registration File 115. Specifically, in Reference 269, the RevBot Parser 102 determines that Incoming Request 101 relates to one or more entries in the Node Registration File 115, and then passes control to the Node Processor 114, Reference 267.

RevBot Receiver 16 Operation

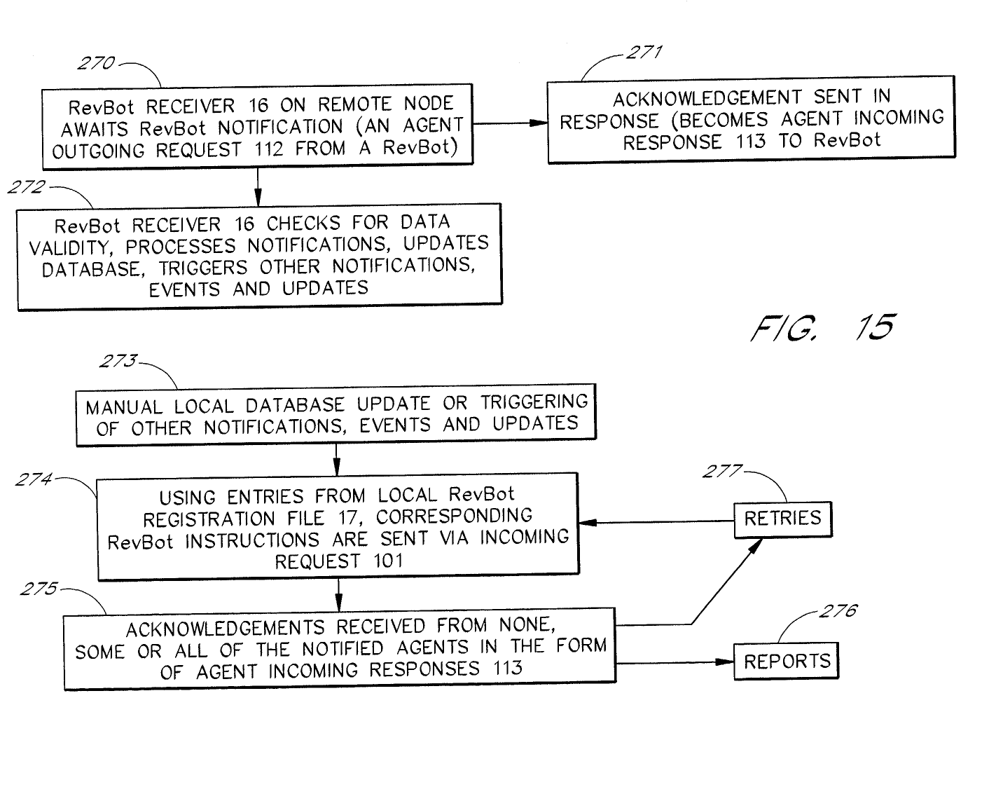

FIG. 15 shows a flowchart of a preferred embodiment of the RevBot Receiver 16. This component of the present invention can be installed on a search engine computing platform to make its communications with RevBots more efficient. In Reference 270, the RevBot Receiver 16 awaits a RevBot's notification that is actually an Agent Outgoing Request 112 from a RevBot. When the RevBot Receiver 16 receives a properly formed notification, in Reference 271, it sends an acknowledgement in response. From the receiving RevBot's perspective, this acknowledgement becomes an Agent Incoming Response 113. In Reference 272, the RevBot Receiver 16 checks the notification for data validity, and, if the notification is determined to be valid, RevBot Receiver 16 processes the notification including updating its databases, and optionally triggering other notifications, events and updates elsewhere in the network.

An alternate embodiment of the RevBot Receiver 16 can check the validity of the notification before responding with the acknowledgement. Should the notification be deemed invalid, that determination can be transmitted as part of the acknowledgement back to the RevBot. Even without such acknowledgements, a RevBot can still check the search engine website to see if the change request was processed properly and if the search engine accurately reflects the RevBot's website contents. If not, the RevBot can issue additional notifications using Agent Outgoing Requests 112.

In Reference 273, when a manual update of the local database or triggering of other notifications, events and updates is performed, instructions can be sent to one or more RevBots via Incoming Request 101 as shown in Reference 274. Then, in Reference 275, acknowledgements are received from some or all of the notified RevBots in the form of Agent Incoming Responses 113. In cases where a RevBot response is not forthcoming within a certain period of time, in Reference 277, retries at network communication are attempted. In Reference 276, reports can be generated for viewing by search engine and network administrators to evaluate and adjust the RevBot Receiver 16 performance.

RevBot-Enabled E-Commerce

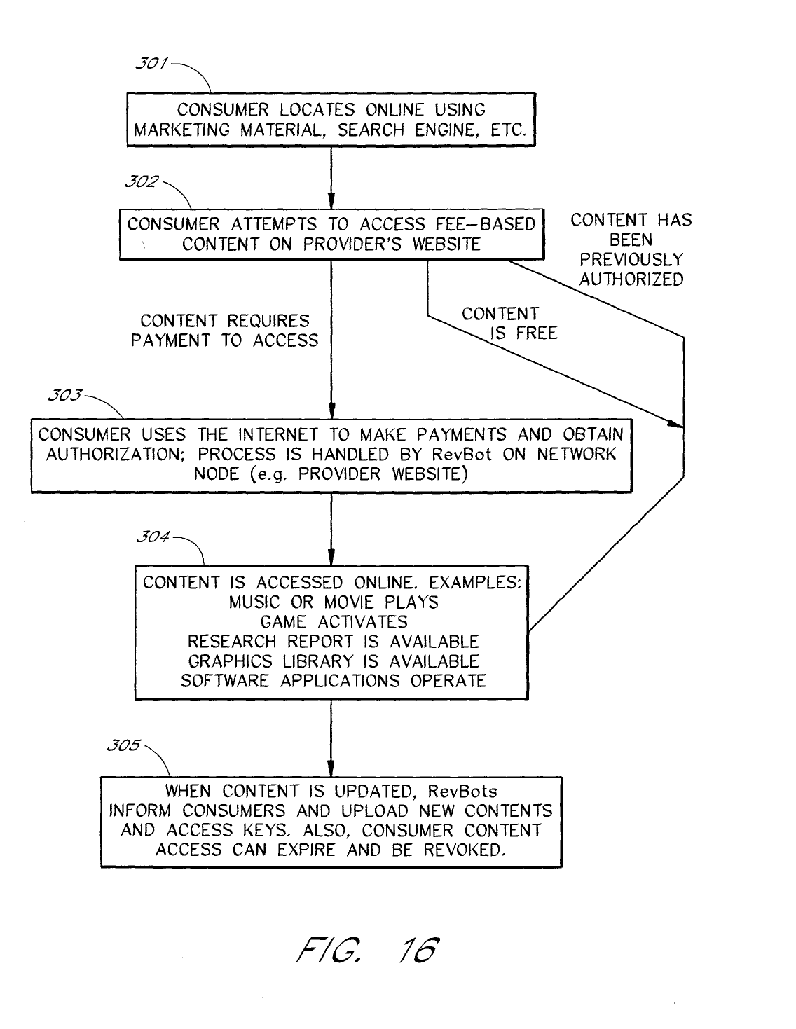

FIG. 16 shows a flowchart of RevBot-based e-commerce for consumers to access fee-based content online. A consumer client 2 locates content online 301 by reference marketing material from an advertisement on television, radio, newsprint, or website, or by using a search engine whose database may have been updated as a result of an automatic update by a RevBot. Then, the consumer attempts to access the fee-based content 302. At this point, there are three possibilities. The first is that the content is in fact free, so the consumer is allowed access immediately. The second is that the content has been previously authorized and the authorization is still valid, so the consumer is allowed access immediately. The third is that the content requires payment in order for the consumer to gain access, so a process is initiated whereby the consumer uses the network (e.g. the Internet) to make a payment and obtain authorization 303.

With proper authorization, the consumer is able to access the content. Some examples of premium content being accessed is provided in FIG. 16.

As time marches on and the number of times the consumer accesses the content increases, the RevBot associated with the website providing content can automatically inform the consumer that there have been changes to the content. If some of the content was downloaded, the RevBot can enable a download of the pertinent content changes. Also, if access to content is limited by RevBot rules, then authorization for the consumer to access the content will cease once the conditions are met. An example is when a consumer is allowed to view a movie five times; another example is when a consumer is allowed to listen to a particular album for three months.

Also, RevBots allow licenses to be revoked and therefore authorization for consumers to access content to cease. This can be caused by a detected violation on the consumer's part, or it could be business-related. For example, a website with the rights to provide a particular artist's content may have to change or eliminate a consumer's access when the artist and the provider website alter or terminate their agreement.

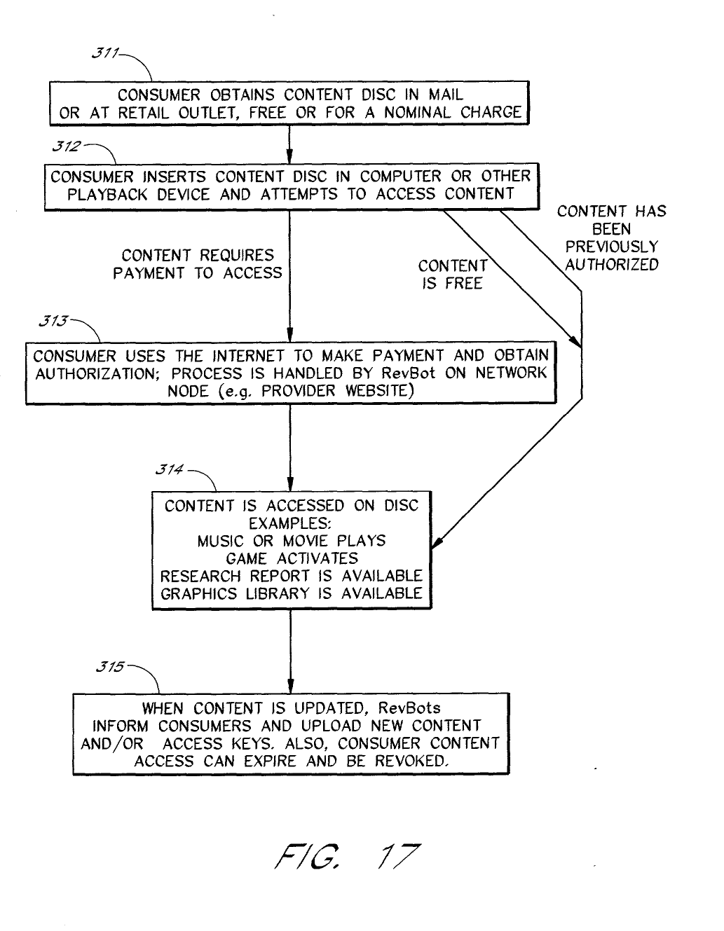

FIG. 17 shows a flowchart of RevBot-based e-commerce with physical distribution. This flowchart is very similar to that of FIG. 16 except that the content being authorized is not being transmitted over the network (e.g. the Internet) put instead on convenient, physical storage such as a CD or DVD. The data transmission rate of most networks including the Internet is generally too low for sustained high-quality transmission of movies or a total download would simply take an unreasonable amount of time, certainly more time to download that it will take for a consumer to watch the movie. So a physical distribution is one way to bypass the network's communication bottleneck but still using the process described above for FIG. 16 for transmitting access keys.

The consumer obtains the storage unit such as a CD or DVD disc either through the mail or at a retail outlet 311. He then inserts the disc into his personal computer or other playback device and attempts to access the content 312. At this point, there are three possibilities. First, the content the consumer is attempting to access is free, so he is given immediate access. Second, the consumer's access to the content has been previously authorized and the authorization is still valid, so he or she is granted immediate access. Third, access to the content requires payment, so a process is initiated whereby the consumer uses the network (e.g. the Internet) to make a payment and obtain authorization 313 typically in the form of a digital key. This key is then used to access the content on the disc.

With proper authorization, the consumer is able to access the content on the physical storage. Some examples of premium content being accessed is provided in FIG. 17.

As time marches on and the number of times the consumer accesses the content increases, the RevBot associated with the website providing content can automatically inform the consumer that there have been changes to the content. Depending on distribution policies, the RevBot can enable a download of the pertinent content changes or schedule the consumer to receive an element of physical storage containing the content update. Also, if the case that access to content is limited by RevBot rules, then authorization for the consumer to access the content will cease once the conditions are met as discussed above for online content.

Also, RevBots allow licenses to be revoked and therefore authorization for consumers to access content to cease. This can be caused by a detected violation on the consumer's part, or it could be business-related as discussed above for online content.

Operation of the RevBot Efficiency Server 18

One or more of the RevBot Efficiency Servers 18 can be advantageously installed in strategic locations around the network 1 so as to further enhance the performance of RevBots. RevBot Efficiency Servers 18 perform a number of tasks including (1) notifying RevBots of search engine events such as new addresses and temporary or permanent shutdowns, (2) providing a more centralized location for storing and processing data that RevBots can use, (3) validating the operations of RevBots, (4) performing some of the RevBot operations for particular RevBots that might be down for service or are behind a security firewall, and (5) monitoring and adjusting the load of RevBot and RevBot Receiver requests and responses. In this sense of having partially centralized control, RevBots are a collection of nodes like any other with which those skilled in the art of network management would know how to implement these functions.

The RevBot Efficiency Server 18 can also help RevBot Receivers 16 to update RevBots. An example is when a search engine company changes its domain or IP address. Updating all of the RevBots associated with the search engine may be a large task that can be broken up and run in parallel by several RevBot Efficiency Servers 18. In this manner, this search engine to RevBots update can occur considerably faster.

RevBot Efficiency Servers 18 help prevent malicious behavior and sabotage by providing centralized facilities for performing the classification of a plurality of websites using RevBots. In this case, RevBot Efficiency Servers 18 act as a gateway to validate RevBots requests so as to prevent a malicious node from transmitting erroneous notifications, especially to search engines. Public keys, such as those available with PKI, or other secure means can be employed as part of the validation process.

RevBots can Help in the Categorization of Data

Referring to FIG. 3, when notifications are transmitted to search engine computing platforms, the Agent Outgoing Requests 112 can include Content Validator 108 and Scorer 119 results based on any standard. As a result, the search engine's database can benefit from this additional content organizing information. Also, when a RevBot's rules are changed, website content may be reevaluated under the new rules and appropriate notifications sent out. In other words, the update of search engine databases can occur when the rules change as well as when content changes.

Multimedia

Multimedia presents a particular challenge to organizing content, especially in the realm of content filtering and blocking. The present invention allows different types of data to be organized in many different ways that can be tailored to suit particular groups (e.g. local schools) or individuals (e.g. for a particular kind of business). Scoring can be accomplished by combining the results of calculations that use website contents and additional information provided by website administrators as input variables.

The present invention removes the restriction of existing search engines and content filtering and blocking software by allowing all web site content, no matter the media type, to be identified and signed. This can be accomplished by using a data encryption method to digitally sign the content and by embedding within the content digital “watermarks” that define characteristics of the data including the type of data, its creator, and its intended use. The methods for digital watermarking are well known in the computing industry.

Multimedia, whether audio, video or a combination of both, is often sourced, directly or indirectly, from files on a website. Since these files have been “signed” in some way, tampering can be easily detected. The present invention can detect such tampering and notify website administrators and also search engines so that they will not return search results pages that link to the website until the tampering has been checked out.

Upgradeability of Existing Filtering Technology

Existing filtering technology can be upgraded to make use of the present invention. The present invention places active logic at websites so as to enable more efficient evaluation of content. Existing standards can be easily adapted to this new paradigm, although the distributed nature of content evaluation and organization provided by the present invention allows for more advanced standards. The present inventions can support independent evaluations of other websites, for example those that follow the PICS standard.

RevBots can Act as an Enhanced Content Manager to Websites

Certain websites desire access to other websites, such as those of a related nature. Instead of implementing a complicated robot application of its own that scours the network and contributes to network slow-downs or instead of using an out-of-date search engine, a web site can simply use the RevBot network. By leveraging data already gathered and organized by RevBots, websites can locate and connect up with one another with ease. Such an advantage can lead to more e-commerce, business-to-business (B2B) and business-to-consumer (B2C) activity.

RevBots can Act as an Enhanced Content Manager between Clients

As peer-to-peer software improves, client-to-client configurations such as browser-user to browser-user are becoming more popular. Network communication models like those from Napster and mp3.com represent a new way of passing data and conducting business, and a new method to ensure that certain clients' data is protected and can be filtered and blocked from other clients.

RevBots can Enhance Security Services

Security services such as Verisign's Public-Key Infrastructure (PKI) are available to enable more secure communications between clients (e.g. different browser users), not just between clients and servers (e.g. browsers and websites). VeriSign, Inc. is located at 1350 Charleston Road, Mountain View, Calif. 94043. RevBots, as active participants, can help streamline the security process. For example, with RevBot's content filtering and blocking operations, only the requested and allowable information is made available, not all of the information which, when transmitted, would take up unnecessary network bandwidth.

A website's RevBot monitors for the website or its contents being compromised at which point the RevBot can take some of all of the following actions depending on the severity of the offense: (1) prevent the compromised content from being sent over the network in its usual manner, locking the website out of the network; (2) flag attempts of unauthorized changes and access by maintaining a log and by transmitting notifications such as emails, voice mails and pages to website administrators; (3) automatically or semi-automatically (e.g. with the aid of a person) reporting the offense to policing authorities; (4) notifying search engines and other network databases that the website has been compromised so that referring links can be temporarily redirected or shut off; (5) while still allowing access by website administrators to review the website, make changes, and release the content lock to allow content to once again be available on the network in its usual manner.

Another feature of a RevBot is that it can make one or more backups of its website and restore compromised website contents from these backups. In this case, the website may not need to be locked out, but the RevBot can still log the event and notify the website administrators and policing authorities.

Notifications to Administrators about Special Situations

When events occur such as broken links, low memory conditions, and illegal attempts to access portions of the website, the website's RevBot keeps and logs these events and can send out email notifications. In this way, a website administrator can be alerted to conditions without having to monitor the website full-time.

With broken links, the RevBot can periodically check to see if all of its website links are valid and that the content on the other side has not changed. If the link is broken or if the content pointed to by the link has changed, the website's administrators can be automatically notified.

RevBots notify different clients about changes to the website based on their individual profiles. Administrators may want verification of any and all changes to a website. The occasional website visitors may only want to be notified when a particular web page changes or when a new section is added to the website.

Using its scorer, a RevBot can ignore certain website changes but send out notifications for other types of changes. Examples are a guest book or discussion forum whose content changes routinely, and minor changes to content such as grammatical corrections. The points at which notifications are triggered or suppressed can be set in the RevBot's rules file.

RevBots Sharing of Data

RevBots can locate other RevBots and consolidate information, including sharing and comparing rules. Such “metarules” conglomerations provide for a higher level of analysis, evaluation and performance across the entire network.

With no or appropriate security, RevBots can locate and update the lists maintained by other RevBots. A cascade effect can cause all of the RevBots on a particular network to synchronize and to evenly distribute information depending on the most efficient topology for the given applications.

Should any part of the network be down and inaccessible, the RevBots can be programmed with an algorithm to wait and retry when that portion of the network is back up and running or delegate this task to a RevBot Efficiency Server.

RevBot Operating Models for Search Engines

There are two primary operating models for RevBots operating with network search engines, Simulate Mode and Notify Mode.

Simulate Mode is for existing search engine interfaces. A RevBot identifies the search engine by a number of different means, including searching for them itself, accessing a common list on a particular network node, and noticing which search engine bots access the website. In any case, the RevBot accesses the search engine in a similar way a website administrator would, by typing into one of the search engine's standard forms. Usually, when a search engine obtains one of these filled-out forms, it will place a priority on accessing that website.

Notify Mode is for search engines that are set up to understand RevBots and therefore use RevBot Receivers 16 to efficiently receive RevBot transmissions. This new type of interface allows for automatic update that is more efficient and faster than the Simulate Mode.

In either Simulate or Notify Mode, the RevBot monitors for update acknowledgments from the various search engines to which it sent notices and retries in the case that a search engine does not acknowledge (primarily Notify Mode) or appear to have updated its database (primarily Simulate Mode). Also, a RevBot sends notifications and reports to site administrators with preselected detail and summary information about its activities. RevBots can check whether the search engine has incorporated its requested changes by checking the search engine's website directly, as a browser user would.

Reverse Proxy RevBot Servers can act as a firewall or buffer between particular websites and the network 1. The applications and use of proxy servers is well known in the computing network trade.

Deployment

RevBots 6 can be installed on any given number of website and start operating immediately, even without RevBot Receivers 16 and RevBot Efficiency Servers 17. In this case, the search engine computing platforms would have no special knowledge about RevBots 6 and their functions. RevBots 6 would still request changes be made to search engine databases, essentially simulating what a human being might do to achieve the same result. Then, they could verify whether the appropriate change was made. If not, they can continue to make requests. At any point during this process, the RevBots 6 could provide status reports to the website administrators.

Given the nature of data organization on a network, it may be advantageous to first deploy RevBots 6 from principal search engine computing platforms. RevBots are sent to the administrators of all of the registered websites 7 for evaluation and installation. Once installed on a website 7, the RevBots begin their activities based on a preset set of parameters which are fine-tuned by the website or search engine administrators. As there is no strict requirement that all RevBots become active at once or that all website must have RevBots, the RevBots become active one at a time. With this method, RevBots are deployed at a fast rate. Working with website server software developers, RevBots either self-install onto web servers or the web servers are provided with RevBot technology already installed.

Updates occur faster and more reliably with the involvement of search engine computing platforms. The deployment of RevBot Receivers 16 can be automatic or semiautomatic in a manner similar described above for RevBots 6, or they could be deployed on a case-by-case basis. In either case, their parameters are configured for optimum performance within each search engines' computing platform.

For installing and maintaining a RevBot and its rules on a website platform, a RevBot functions are integrated with software development tools. For example, software plug-ins as are well known in the software development community can be developed for use with popular tools such as Unix Apache Server, available from the Apache Software Foundation, Forest Hill, Md., and with the Visual InterDev and Visual SourceSafe products from Microsoft Corporation, Redmond, Washington.

Enhanced Access by Search Engines to Pay-For-Access Content

Most websites that require user registration or payment access cannot be easily scanned, if at all, by traditional search engine bots. Such pay-for-content websites derive a significant advantage by associating a RevBot 6 or 6A with their pay-for-content site. Such content or any portion of the content by the site can, via a RevBot and at the discretion of the website's administration, now appear in the search results provided by a search engine, whereas, before RevBots, the same content did not appear. The search engine results can include whether or not the content is free, requires website visitors to register (e.g., with a user ID), or needs to be paid for and how. This method of content management solves a significant problem with today's search engine databases, namely that content that is not free is often not represented. The problem is so pervasive that such restricted content is referred to by many names including “the invisible web” and “the deep web” since it is not represented on search engine results. The solution provided by the present invention is at least to allow network clients 2 to be aware that the content exists and then let them decide whether or not to register and/or pay to access that content. This is the process of fee-based content access discussed earlier that brings e-commerce over computing networks closer to traditional commerce, enabling tried-and-true sales methods such as having the goods and services for sale reach their intended markets, posting prices, and inducing the impulse buy. In their notifications, based on their rules, RevBots provide a synopsis of the content as an aid to help clients make their decision. In essence, RevBots help to promote content that would be otherwise unavailable across a network.

E-Commerce and DRM

RevBots 6 enable e-commerce and DRM directly from search engines. As described above, RevBots 6 support fee-based content access. In the case of DRM, a secure communications pathway is established from the website 7 transmitting the restricted content to the receiving consumer's personal computer and data storage devices. In a similar fashion, a secure communications pathway is established from a personal computer to the website 7 for uploading and maintenance by authors, creators and administrators of the restricted content.

RevBots 6 enable e-commerce and DRM directly from clients 2 which include consumer-based personal computers, wireless devices and other network equipment. If a client 2 originally used a search engine 14 to arrive at a website 7 supported by a RevBot 6, then follow-up notifications and transactions take place without necessarily involving the search engine 14. While the client 2 does not perceive differences between a non-RevBot and RevBot-supported website 6, in fact there are many: (1) the client 2 may have become aware of the website 7 using information provided to the search engine 14 by way of the RevBot 6; (2) the RevBot participates in authorizing access, determining what kind of access to provide, and participates in the collection of fees; (3) ongoing access and use is monitored by the RevBot 6; and (4) follow-up updates can be initiated by the RevBot to the client 2, bypassing the search engine 14, ensuring that the client 2 has the most up-to-date copy of or access to the restricted content.

In both cases, the fee structure, recording and reporting is set in the RevBots 6 rules. If real-time credit card, debit card, credit account, debit advance, micropayment or other payment method is desired by the website, the RevBots 6 securely notify and obtain authorization from appropriate other network nodes which provide those services. Credit account means on account where the client gets a bill after the fact. There is typically a credit limit associated with a credit account. Debit advance means to debit a prepaid balance as long as the balance covers the charge.

Additional Income for RevBot Operator

For fee-based content access, RevBot operators who may or may not be independent from the webstite administrators can obtain a portion of various payments such as the service of notifying search engines, especially about restricted content. In the preferred embodiment, payments to the RevBot operator are provided by a portion of payments made by clients to access the restricted content (e.g. from micropayments) or a fee collected directly from the website owner or operator.

Examples of fees are (1) a flat fee, and (2) a variable fee based on the number of notification updates and/or the number of clickthroughs or some other access criteria. Also, the fee is either (3) paid in advance, (4) billed on terms, or (5) billed periodically. In support of this payment methodology, the RevBot can notify the website administrators when the advance drops below a certain point or when the credit rises past a certain amount, the credit limit. In an alternate embodiment, RevBots can also automatically or semi-automatically (e.g. by involving a person) bill for their services and notify website administrators about these automatic transactions, especially should one or more of them fail to clear.

A RevBot can inform search engine computing platforms of keywords and keyword combinations its website would like to own and automatically offer payment for referrals based on owning those keywords and keyword combinations. The RevBot can perform automated or semi-automated price negotiations based on RevBot parameters defined by the website administrators. As part of the RevBot rules, semi-automatic negotiations can involve a person who is notified (e.g. by email, by phone) as part of the process.

Another source of additional income for a RevBot enabled website is from service level agreements as are well known in the network community that the website owners can make with search engine companies. For example, a RevBot enabled website can provide the service of indexing incremental website changes published at a certain frequency and within a specific time span.

RevBots can Purchase and Sell

In the arena of online advertising, RevBots can arrange for an automated exchange of advertisements to occur. A RevBot can perform automated and semi-automated (e.g. with the assistance of a person) purchases and sales, including the purchase and sale of banner advertisements. By way of example of a sale, when communicating with participating nodes, a website's RevBot can notify them that there is an existing inventory of a certain number of advertising impressions per day available for sale on the RevBot's website. Participating nodes that respond with an acceptance then specifies their advertisements which can immediately begin to appear on the website. As a further development of this example, through its RevBot, a website's administrator can specify keywords for individual pages so that advertising space can be more precisely targeted.

As well as selling, RevBots can also make purchases. By way of example for a purchase, a RevBot can indicate that it is willing to pay up to a certain amount for a certain number of advertising impressions on a particular node. Should that node accept the RevBot's offer, the RevBot can then specify the one or more advertisements which can immediately begin to appear on websites belonging to the node.

### Conclusion

As discussed above, this invention provides a number of significant features and advantages for organizing and promoting content across a computer network. This invention eliminates significant delays in the update of search engine databases relating to website content changes, including content additions and deletions. It speeds up the processes of searching and recalling information, and it allows network clients such as consumers to obtain more appropriate, up-to-date content and information and to optionally receive ongoing updates. The addition of active logic to a website in the form of a RevBot is the key to improving the management of network content. RevBots protect website contents by performing content validation, limiting, filtering and blocking operations, and they augment website content by injecting additional content into the content data stream. They improve network performance and data security by efficiently executing their operations local to the website instead of by using a remote process that would require additional, possibly unsecured, network traffic. Because RevBots perform content request validation and establish secure communication pathways, they improve the performance of e-commerce, DRM platforms, and regular commerce especially in the realm of physical distribution. Because they are independent from the website they supervise and can communicate using secure communication protocols, they assist in maintaining content integrity, network security and personal privacy. RevBots supervise and act on website requests, initiate network requests in support of their own operations, and monitor for certain conditions that should be logged or reported. Different configurations of RevBots can be designed to work within and expand beyond established network topologies. Two other components of the invention, the RevBot Receiver for search engine computing platforms and RevBot Efficiency Servers can optionally further enhance RevBot and network performance.

Although this invention has been described in terms of certain preferred embodiments, other embodiments that are apparent to those of ordinary skill in the art, including embodiments which do not provide all of the benefits and features set forth herein, are also within the scope of this invention.

What is claimed is:

1. The method of enabling a website to automatically and immediately notify one or a plurality of nodes on a network about changes to the content of said website comprising:
automatically transmitting a request over said network to one or more selected nodes;
determining whether a response is received from a node;
automatically retrying to contact a node that does not respond; and
automatically transmitting to each responding node to add, adjust, update or remove an entry concerning said website stored by said search engine.

2. The method of enabling a website to automatically and immediately notify one or a plurality of search engines computing platforms on a network about changes to the content of said website comprising:
automatically transmitting a request over said network to one or more selected search engine computing platforms;
determining whether a response is received from a search engine computing platform;
automatically retrying to contact a search engine computing platform that does not respond; and
automatically transmitting to each responding search engine computing platform to add, adjust, update or remove an entry concerning said website stored by said search engine;

3. The method of enabling a website to perform a transaction with one or a plurality of nodes on a network comprising:
communicating the proposed transaction selected nodes;
determining whether a response is received from a node;
retrying to contact a node that does not respond; and
completing the transaction with one or more nodes.

4. The method of claim 3, wherein said proposed transaction comprises a sale.

5. The method of claim 4, wherein the sale of advertisements on that node or nodes is the subject of said proposed transaction.

6. The method of claim 3, wherein said proposed transaction comprises a purchase.

7. The method of claim 6, wherein the purchase of advertisements on said node or nodes is the subject of said proposed transaction.

8. The method of claim 3, wherein said transactions is one of e-commerce.

9. The method of claim 3, wherein said transactions support distribution of goods or services.

10. The method of claim 3, wherein said transactions support distribution of services.

11. The method of claim 3, wherein said transactions protect copyrighted material.

12. The method of 3, wherein said transactions protect intellectual property.

13. The method of enabling a website to automatically limit, filter, block or enhance content transmitted to a client over a network comprises,
storing at said website a list of node network locations,
storing at said website a set of rules selected by said client,
processing incoming requests for content from said client, and
modifying the content sent to said client in accordance with the rules selected by said client.

14. The method of claim 13, wherein said rules include client requests for limiting, blocking and enhancing site content.

15. The method of claim 14 comprises providing said client with a sliding scale control.

16. The method of claim 13 automatically including receiving data from other websites and adding such data to the content transmitted to said client.
